(19) United States
(12) Patent Application Publication
(10) Pub. No.: US 2016/0364415 A1
(43) Pub. Date: Dec. 15, 2016

(54) INFORMATION PROCESSING SYSTEM, INFORMATION PROCESSING APPARATUS, AND INFORMATION PROCESSING METHOD

(71) Applicants: Atsushi ITOH, Kanagawa (JP); Yuki WAKITA, Tokyo (JP); Hidenobu KISHI, Kanagawa (JP); Kunikazu OKAJIMA, Kanagawa (JP)

(72) Inventors: Atsushi ITOH, Kanagawa (JP); Yuki WAKITA, Tokyo (JP); Hidenobu KISHI, Kanagawa (JP); Kunikazu OKAJIMA, Kanagawa (JP)

(73) Assignee: Ricoh Company, Ltd., Tokyo (JP)

(21) Appl. No.: 15/177,666

(22) Filed: Jun. 9, 2016

(30) Foreign Application Priority Data
Jun. 12, 2015 (JP) 2015-119583

(51) Int. Cl. G06F 17/30; G06K 9/62

(52) U.S. Cl. CPC G06F 17/30268; G06K 9/6215

(57) ABSTRACT

An information processing system includes: a terminal; an image retrieval device that retrieves an image similar to a retrieval subject image from a registration unit in which an image and association information are registered in an associated manner; a campaign-information registration unit that registers first campaign information and second campaign information in an associated manner, out of campaign information that includes an image and association information associated therewith; a storage unit that stores, as history information, the campaign information corresponding to the image based on a retrieval subject image transmitted from the terminal and identification information to identify the terminal in an associated manner; and a presenting unit that presents, to the terminal, association information that is included in the second campaign information registered in the campaign-information registration unit with being associated with the first campaign information that is associated with the identification information of the history information.

### CROSS-REFERENCE TO RELATED APPLICATION

The present application claims priority under 35 U.S.C. §119 to Japanese Patent Application No. 2015-119583 filed in Japan on Jun. 12, 2015. The contents of which are incorporated herein by reference in their entirety.

### BACKGROUND OF THE INVENTION

1. Field of the Invention

The present invention relates to an information processing system, an information processing apparatus, and an information processing method.

2. Description of the Related Art

An image retrieval technique has been known in which feature points are extracted from, for example, a captured image that is obtained by imaging with a camera, and an image having many feature points similar to the captured image is retrieved from a group of images that are registered in advance. An image retrieval system using this image retrieval technique has been known in which images of specific photographs and printed materials are registered in a database associating with various electronic data, a similar image is retrieved from this database based on captured images that are obtained by imaging these photographs and printed materials, and association information that is associated with the similar image is presented (for example, Japanese Laid-open Patent Publication No. 2014-010723).

There can be another association information relating to the association information presented based on the captured image. In the image retrieval system according to a conventional technique, it has been difficult for the user that has performed image retrieval to obtain such another association information. As an example, when such another association information is released chronologically later than the release date of the association information that has been presented based on the captured image, it can be difficult for the user to obtain such another association information in the image retrieval system according to the conventional technique.

A uniform resource locator (URL) of a web site can be used as association information presented based on a captured image. In this case, a registration means of user information can be provided at the web site, and an associated event can be notified to a user from the web site. However, in this case, the user is required to register identification information, such as a user name and a password, to identify the user, and it can be an extra work for the user.

In view of the above problem, there is a need to enable easy acquisition of association information that is associated with association information that has been acquired in image retrieval.

### SUMMARY OF THE INVENTION

It is an object of the present invention to at least partially solve the problems in the conventional technology.

According to exemplary embodiments of the present invention, there is provided an information processing system comprising: a terminal device; an image retrieval device that includes a retrieving unit that retrieves an image similar to a retrieval subject image from an image-information registration unit in which an image and association information are registered in an associated manner, and a transmitting unit that transmits association information that is associated with a retrieved image to the terminal device; an information processing apparatus that controls registration of the association information to the image-information registration unit; a campaign-information registration unit that registers first campaign information and second campaign information in an associated manner, out of campaign information that includes the image and the association information associated with each other; a storage unit that stores, as history information, the campaign information corresponding to the image retrieved by the retrieving unit based on the retrieval subject image transmitted from the terminal device and identification information to identify the terminal device in an associated manner; and a presenting unit that presents, to the terminal device, association information that is included in the second campaign information registered in the campaign-information registration unit with being associated with the first campaign information that is associated with the identification information of the history information.

Exemplary embodiments of the present invention also provide an information processing apparatus that controls registration of association information to image-information registration unit performed by an image retrieval device that includes a retrieving unit that retrieves an image similar to a retrieval subject image from the image-information registration unit in which an image and association information are registered in an associated manner, a transmitting unit that transmits association information that is associated with a retrieved image to a terminal device, a storage unit that stores campaign information including the image and the association information that correspond to the image retrieved by the retrieving unit based on the retrieval subject image that is transmitted from the terminal device, and that are associated with each other, and identification information to identify the terminal device in an associated manner, and a presenting unit that presents, to the terminal device, association information included in second campaign information that is included in the campaign information and that is registered in an associated manner with first campaign information included in the campaign information associated with the identification information of the history information, the information processing apparatus comprising: an input unit that accepts a user input; a specifying unit that specifies the second campaign information to be associated with the first campaign information associated with image information that includes the image and the association information, according to the user input made to the input unit; and an association-information transmitting unit that transmits, to the image retrieval device, the first campaign information and the second campaign information that is specified by the specifying unit with respect to the first campaign information in an associated manner.

Exemplary embodiments of the present invention also provide an information processing method for an information processing system that includes a terminal device, an image retrieval device, and an information processing apparatus, the image retrieval device having a retrieving unit that retrieves an image similar to a retrieval subject image from an image-information registration unit in which an image and association information are registered in an associated manner, and a transmitting unit that transmits association information that is associated with a retrieved image to the terminal device, the information processing apparatus controlling registration of the association information to the image-information registration unit, the information processing method comprising: registering first campaign information and second campaign information in an associated manner, out of campaign information that includes the image and the association information associated with each other; storing, as history information, the campaign information corresponding to the image retrieved by the retrieving unit based on the retrieval subject image transmitted from the terminal device, and identification information to identify the terminal device in an associated manner; and presenting association information that is included in the second campaign information registered at the registering with being associated with the first campaign information that is associated with the identification information of the history information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram schematically illustrating a configuration of one example of an image retrieval system that is applicable to an embodiment of the present invention;

FIG. 2 is a functional block diagram of one example for explaining functions of a retrieval server according to the embodiment;

FIG. 3 is a diagram illustrating one example of an Extensible Markup Language (XML) code that describes information indicating a target region according to the embodiment;

FIG. 4 is a diagram schematically illustrating an example of a structure of a campaign advertisement (hereinafter referred to as campaign) according to the embodiment;

FIG. 5 is a diagram illustrating an example of campaign information that is stored in a campaign information database (DB) according to the embodiment;

FIGS. 6A to 6C are diagrams illustrating other examples of campaign information that is stored in the campaign information DB according to the embodiment;

FIG. 7 is a diagram illustrating an example of history information that is stored in a history DB according to the embodiment;

FIG. 8 is a diagram schematically illustrating a configuration of one example of an information processing system according to the embodiment;

FIG. 9 is a block diagram illustrating a configuration of one example of hardware of a registration terminal applicable to the embodiment;

FIG. 10 is a block diagram illustrating a configuration of one example of hardware applicable to a retrieval server according to the embodiment;

FIG. 11 is a block diagram illustrating a configuration of one example of hardware of the retrieval terminal applicable to the embodiment;

FIG. 12 is a functional block diagram of one example for explaining a function of the registration terminal according to the embodiment;

FIG. 13 is a functional block diagram of one example for explaining a function of a retrieval terminal applicable to the embodiment;

FIG. 14 is a flowchart illustrating one example of image registration processing that is performed by a registration tool according to the embodiment;

FIG. 15 is a diagram illustrating an example of a login screen applicable to the embodiment;

FIG. 16 is a diagram illustrating an example of a menu screen applicable to the embodiment;

FIG. 17 is a diagram illustrating an example of a registration-information list screen applicable to the embodiment;

FIG. 18 is a diagram illustrating an example of a public setting screen applicable to the embodiment;

FIG. 19 is a diagram illustrating an example of a campaign registration screen applicable to the embodiment;

FIG. 20 is a diagram illustrating an example of an edit screen according to the embodiment;

FIG. 21 is a diagram illustrating an example of a file selecting screen applicable to the embodiment;

FIG. 22 is a diagram illustrating an example a campaign setting screen according to the embodiment;

FIG. 23 is a diagram illustrating an example of a warning screen applicable to the embodiment;

FIG. 24 is a flowchart illustrating an operation example of the retrieval terminal according to the embodiment;

FIG. 25 is a diagram illustrating an example of a display screen of push information displayed on the retrieval terminal according to the embodiment;

FIG. 26 is a flowchart illustrating an operation example of the retrieval server according to the embodiment;

FIG. 27 is a diagram illustrating a display example of association information that is displayed on the retrieval terminal according to the embodiment;

FIG. 28 is a diagram illustrating a display example of association information that is displayed on the retrieval terminal according to the embodiment; and

FIGS. 29A and 29B are diagrams showing display examples of association information that is displayed on the retrieval terminal according to the embodiment.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Embodiments of an information processing system, an information processing apparatus, and an information processing method are explained in detail below with reference to the accompanying drawings.

System Applicable to Embodiment

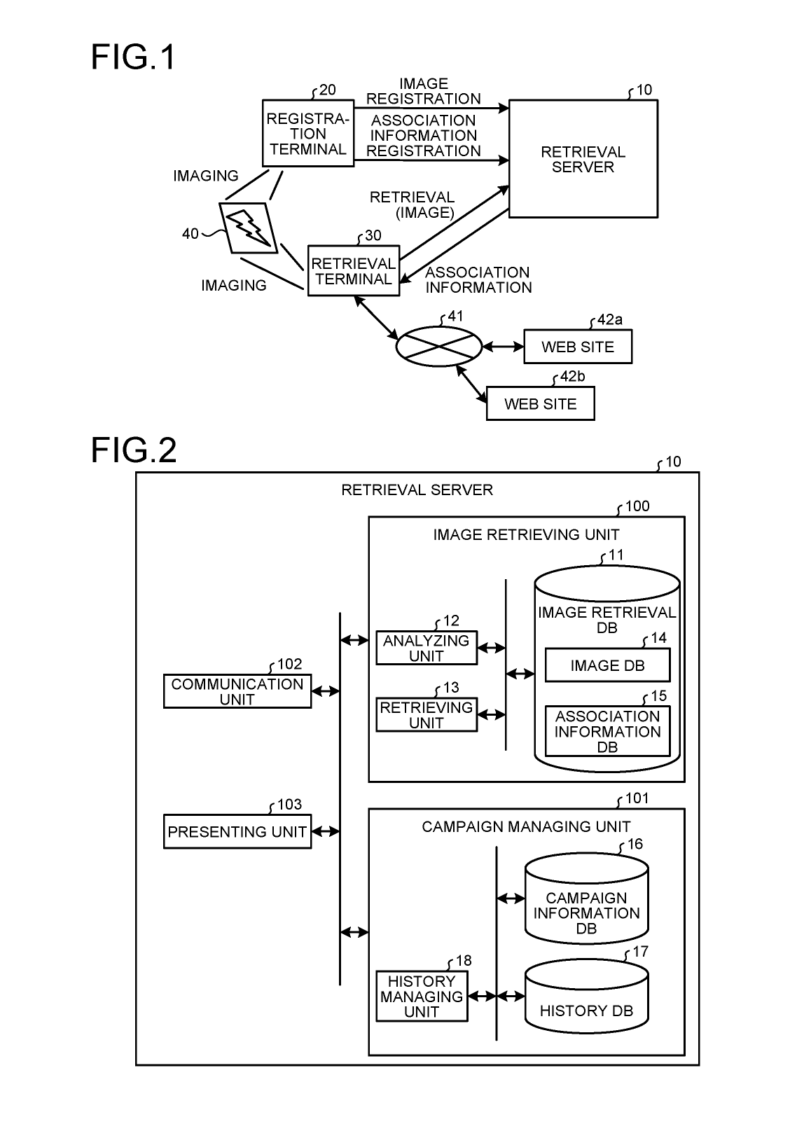

FIG. 1 schematically illustrates a configuration of one example of an image retrieval system that is applicable to an embodiment of the present invention. As illustrated in FIG. 1, the image retrieval system includes a retrieval server 10, and the retrieval server 10 is enabled to communicate with a registration terminal 20 and a retrieval terminal 30 through a network. The retrieval server 10 may be constituted of a single image processing apparatus, or may be constituted of multiple units of image processing apparatuses connected to each other, distributing functions thereto.

The registration terminal 20 acquires an image and association information being associated with the image, to transmit to the retrieval server 10. The retrieval server 10 registers the image and the association information transmitted from the registration terminal 20 in an image retrieval DB in an associated manner. The association information can include, for example, a URL of a web site 42a or a web site 42b on the Internet 41.

In the example shown in FIG. 1, the registration terminal 20 uses a captured image that is obtained by imaging a subject 40 as an image to be registered in the image retrieval DB. It is not limited to this example, but the registration terminal 20 may use an image provided externally or an image created internally in the registration terminal 20 as an image to be registered in the image retrieval DB.

The retrieval terminal 30 has an imaging function, and is capable of transmitting an image obtained by imaging the subject 40 to the retrieval server 10 through a network. The retrieval terminal 30 activates the imaging function, for example, in response to a user operation, to image the subject 40, and transmits an image obtained by imaging and a retrieval request to request retrieval of an image similar to this image, to the retrieval server 10.

The retrieval server 10 retrieves an image similar to the image from the image retrieval DB according to the captured image that has been obtained by imaging the subject 40 and the retrieval request, and acquires identification information of the retrieved image as a retrieval result. The retrieval server 10 transmits association information that is associated with the retrieved image to the retrieval terminal 30.

When, for example, the association information includes a URL, the retrieval terminal 30 can access to the web sited 42a or the web site 42b through the Internet 41 according to the association information that has been retrieved and transmitted by the retrieval server 10 based on the captured image obtained by imaging the subject 40.

FIG. 2 is a functional block diagram of one example for explaining functions of the retrieval server 10 according to the embodiment. The retrieval server 10 includes an image retrieving unit 100, a campaign managing unit 101, a communication unit 102, and a presenting unit 103. The communication unit 102 performs communication among the retrieval server 10, the registration terminal 20, and the retrieval terminal 30. The presenting unit 103 creates information to be presented to the registration terminal 20 and the retrieval terminal 30. The information presented by the presenting unit 103 is transmitted to the registration terminal 20 and the retrieval terminal 30 by the communication unit 102.

The image retrieving unit 100 performs retrieval processing based on a captured image transmitted from the retrieval terminal 30. The image retrieving unit 100 includes an image retrieval DB 11, an analyzing unit 12, and a retrieving unit 13. The image retrieval DB 11 includes an image DB 14 and an association information DB 15. The image DB 14 registers images in a retrievable manner. The association information DB 15 registers association information to be associated with the image registered in the image DB 14 with being associated with the image.

A specific example of association between an image and association information is explained. In the embodiment, one or more region is specified in an image and association information can be associated with each specified region. The region that is specified within an image and to be associated with association information is hereinafter referred to as a target region.

Information indicating a target region is stored and registered in the association information DB 15 in a manner to be associated with image identification information. In the embodiment, the information indicating a target region is described using, for example, XML, which is a kind of a markup language describing a meaning and a structure of data with tags. In the association information DB 15, for example, a file name of a file containing an XML code that describes information indicating this target region, and the image identification information are stored in an associated manner.

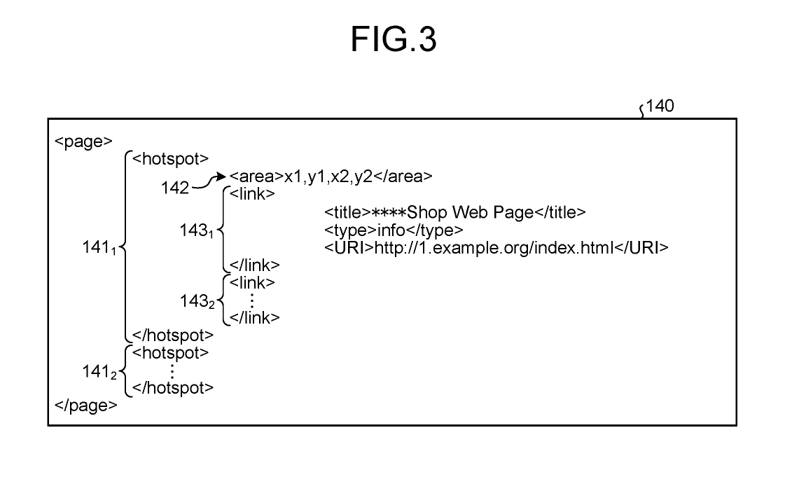

FIG. 3 illustrates one example of the XML code that describes information indicating a target region according to the embodiment. In FIG. 3, an XML code 140 defines a page with a part between the outermost tags “<page>” and “</page>”. That is, one image is associated with the part between the tags “<page>” and “</page>”. In each of parts 141₁ and 141₂, a part between tags “<hotspot>” and “</hotspot>” defines one target region. Thus, more than one target region can be defined for one page (one image).

In the part 141₁, a first line 142 defines a range of the target region in the page with a part between tags “<area>” and “</area>” by, for example, coordinates of an upper left corner (x1, y1) and coordinates of a lower right corner (x2, y2).

In each of parts 143₁ and 143₂, a part between tags “<link>” and “</link>” defines one piece of association information. Thus, more than one piece of association information can be defined for one target region. For example, as exemplified in the part 143₁ in FIG. 3, a part between “<title>” and “</title>” defines a tile of the association information. A part between “<type>” and “</type>” defines a type of this association information.

In this example, as the association information, a part between tag “<URI>” and “</URI>” defines address information on a network such as the Internet 41 with a uniform resource indicator (URI). In this case, by adding an argument to the URI, for example, an action of a browser application reading the URI can be designated. Moreover, the association information is not limited to a URI. By defining a tag in advance, various kinds of association information can be described. For example, as association information, information that activates a specific application program can be described.

Furthermore, in this example, in the association information defined by the part between the tags “<link>” and “</link>”, three items are defined by the tags “<title>” and “</title>”, the tags “<type>” and “</type>”, and the tags “<URI>” and “</URI>”.

It is not limited to this example, but more items can be defined in the part between the tags “<link>” and “</link>”. Image data itself of a target region can be described in the part between the tags “<link>” and “</link>”, by defining the image data as an item.

Thus, the XML code 140 defines a target region in a page and association information in the target region, thereby a function based on the association information that is associated with an object included in the target region in the page can be performed.

The registration processing of an image by the retrieval server 10 is performed roughly as follows. The retrieval server 10 analyzes an image being registered by the analyzing unit 12, and extracts feature information that indicates features of the image. The retrieval server 10 stores the extracted feature information in the image DB 14 associating with image identification information to identify the image. The retrieval server 10 also stores association information being provided to a user into the association information DB 15 associating with the image identification information. The image (the feature information) and the association information are stored in the image DB 14 and the association information DB 15, respectively, and the registration of the image to the image retrieval DB 11 is thereby performed.

The retrieval processing of an image by the retrieval server 10 is performed roughly as follows. For example, an image transmitted from the retrieval terminal 30 is received by the communication unit 102 of the retrieval server 10, and is transferred to the analyzing unit 12 through the retrieving unit 13. The analyzing unit 12 analyzes the transferred image to extract feature information from the image, and transfers the extracted feature information to the retrieving unit 13. The retrieving unit 13 retrieves feature information having high similarity to the feature information from the image DB 14 based on the feature information transferred from the analyzing unit 12. The retrieving unit 13 acquires association information that is associated with image identification information corresponding to the retrieved feature information from the association information DB 15, and transfers it to, for example, the presenting unit 103.

The presenting unit 103 creates presentation information to be presented to the retrieval terminal 30 based on the transferred association information. The created presentation information is transferred from the presenting unit 103 to the communication unit 102, and is transmitted from the communication unit 102 to the retrieval terminal 30.

Returning back to explanation of FIG. 2, the campaign managing unit 101 manages a campaign that includes images registered in the image retrieval DB 11. A campaign according to the embodiment is explained. In the retrieval server 10 according to the embodiment, registration of an image is performed per campaign.

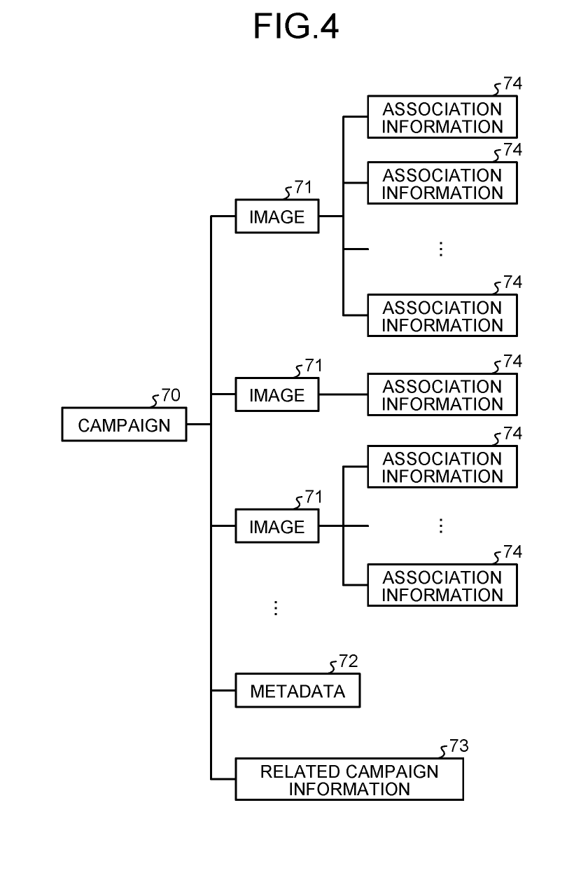

FIG. 4 schematically illustrates an example of a structure of a campaign according to the embodiment. In FIG. 4, a campaign 70 is identified by a campaign identification (ID), and includes one or more images 71, 71, . . . , metadata 72, and related campaign information 73. Each of the images 71, 71, . . . includes one or more pieces of association information 74, 74, . . . . Each of the images 71, 71, . . . included in the campaign 70 is called page. In other words, the campaign 70 includes each of the images 71, 71, . . . per page.

The metadata 72 includes attribute information of the campaign 70. The metadata 72 includes a campaign ID, a campaign name, a client name that has requested registration of the campaign 70 to the retrieval server 10, a date of update when the campaign 70 is updated, a state indicating that the campaign 70 is either released or not released to the public, and the like. The related campaign information 73 is information (for example, campaign ID) indicating another campaign 70 related to this campaign 70.

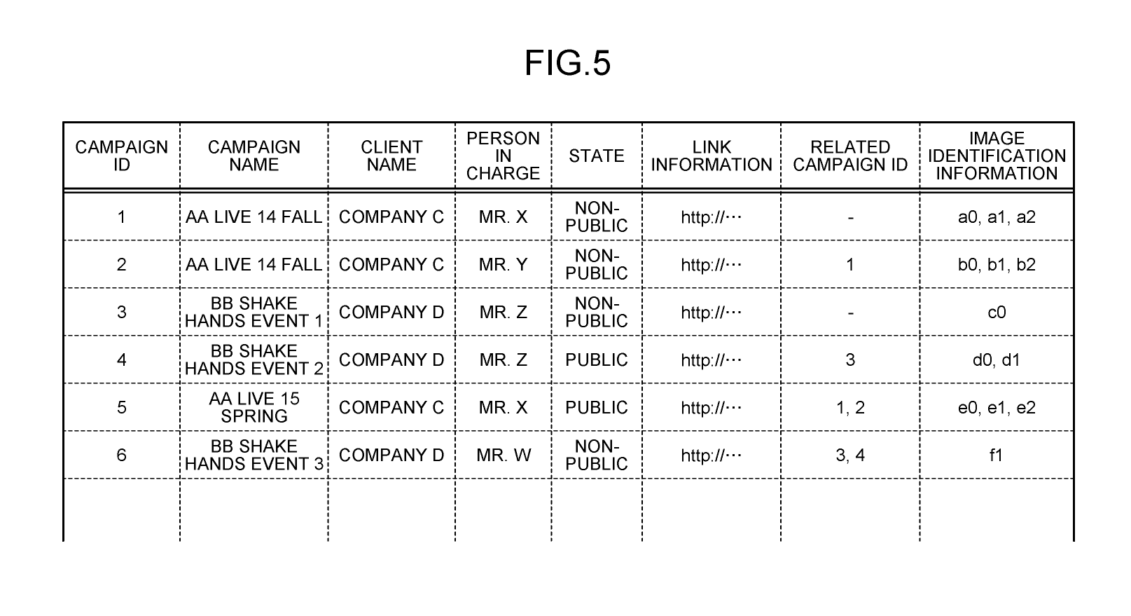

In the example shown in FIG. 2, the campaign managing unit 101 includes a campaign information DB 16, a history DB 17, and a history managing unit 18. The campaign information DB 16 stores information indicating the campaign 70 described above. FIG. 5 shows an example of campaign information that is stored in the campaign information DB 16 according to the embodiment. In the example shown in FIG. 5, campaign information indicating one campaign 70 is shown as a record including items of “campaign ID”, “campaign name”, “client name”, “person in charge”, “state”, “link information”, “related campaign ID”, and “image identification information” in the row direction.

Among the respective items included in the campaign information, for example, the item “campaign name”, the item “person in charge”, the item “state”, and the item “link information” are information included in the metadata 72 described above. Moreover, the item “related campaign ID” is information included in the related campaign information 73.

The item “campaign ID” indicates a campaign ID that is identification information to identify the campaign 70. The item “campaign name” indicates a name set to the campaign 70. The items “client name” and “person in charge” indicate a client that has requested registration of the campaign 70 to the retrieval server 10, and a name of a person in charge, respectively. The item “state” indicates either the campaign 70 is in public state or in non-public state. The item “link information” indicates link information (for example, URI) that is associated with the campaign 70 itself. The item “image identification information” lists image identification information of pages (images) included in the campaign 70.

The item “related campaign ID” indicates a campaign ID of a related campaign, which is another campaign 70 that is associated with the campaign 70. In the example shown in FIG. 5, a campaign of a campaign ID “1” is associated as a related campaign with a campaign of a campaign ID “2”. Moreover, for example, campaigns of the campaign IDs “1” and “2” are associated with a campaign of the campaign ID “5”. Thus, more than one related campaigns can be associated with one campaign.

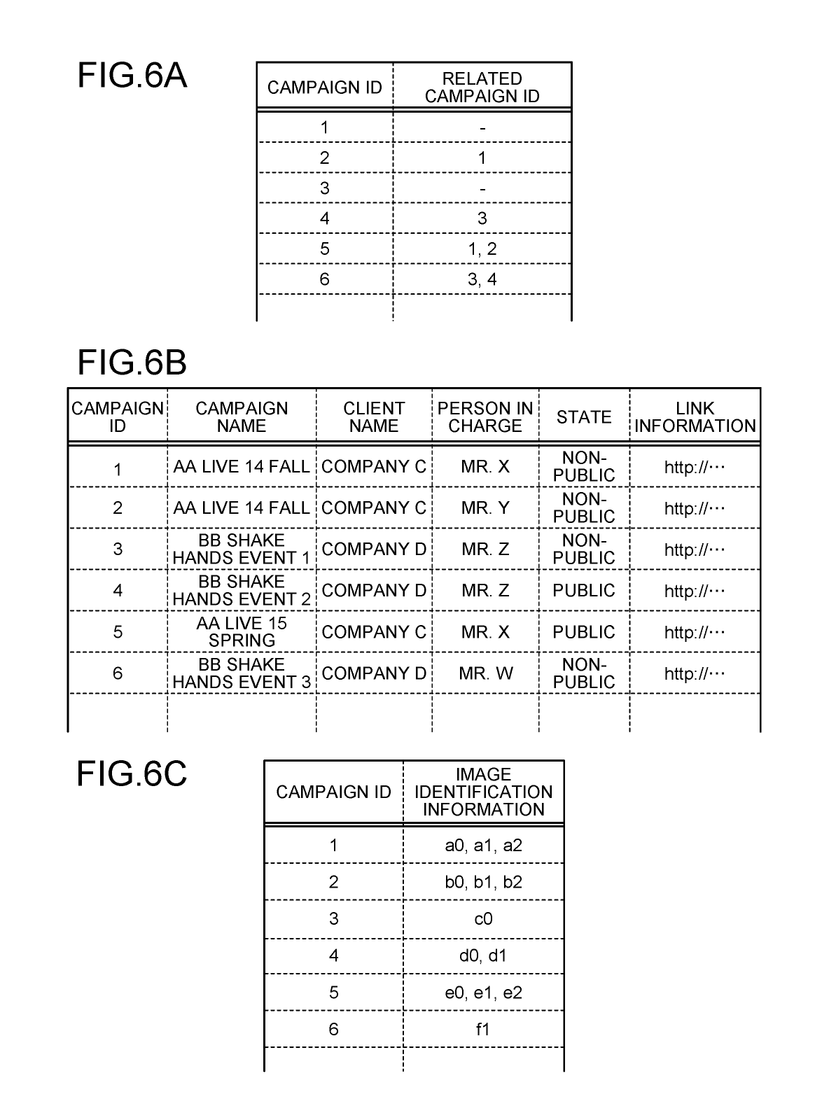

The structure of campaign information is not limited to the example shown in FIG. 5. For example, the campaign information can include further more items as the metadata 72. Furthermore, although campaign information is indicated as one table, it is not limited to this example. The campaign information may be distributed to multiple tables using the campaign ID as a key as shown in FIGS. 6A to 6C.

In the example illustrated with FIGS. 6A to 6C, the campaign information is constituted of a table of FIG. 6A in which the item “related campaign ID” and the item “campaign ID” are associated with each other, a table of FIG. 6B in which the respective items included in the metadata 72 and the item “campaign ID” are associated with each other, and a table of FIG. 6C in which the item “image identification information” and the item “campaign ID” are associated with each other.

Returning back to explanation of FIG. 2, the history DB 17 stores history information indicating a history of image retrieval performed with respect to the retrieval server 10 from the retrieval terminal 30. The history managing unit 18 manages the history information that is stored in the history DB 17. The history managing unit 18 performs storage of the history information to the history DB 17 and retrieval of the history information.

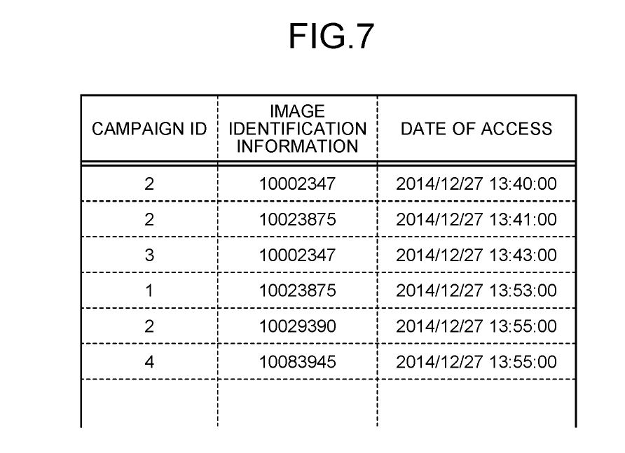

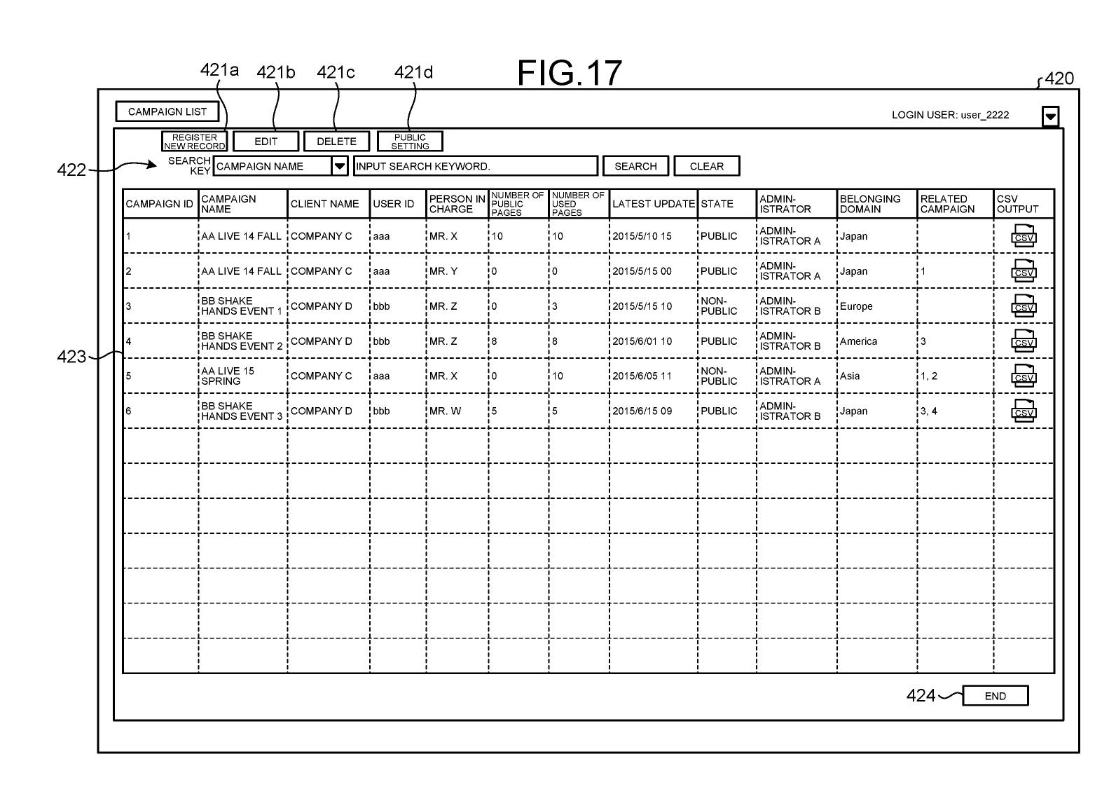

FIG. 7 shows an example of history information that is stored in the history DB 17 according to the embodiment. In the example shown in FIG. 17, the history information includes items of “campaign ID”, “terminal identification information”, and “date of access”.

The item “campaign ID” corresponds to the item “campaign ID” of the campaign information in FIG. 5. The item “terminal identification information” indicates identification information to identify the retrieval terminal 30 that has requested image retrieval to the retrieval server 10. As the terminal identification information, a media access control (MAC) address that is assigned to the retrieval terminal 30 can be used. Not limited thereto, an application ID that is used to perform image retrieval by the retrieval server 10 in the retrieval terminal 30, and that is uniquely created per retrieval application that corresponds to the image retrieval system can be used as the terminal identification information. The application ID is described later. The item “date of access” indicates date on which the retrieval terminal 30 accesses the retrieval server 10 for image retrieval.

Thus, the history DB 17 registers history information per campaign for image retrieval based on a captured image that is transmitted from the retrieval terminal 30. For example, the history managing unit 18 acquires, from the image retrieving unit 100, image identification information of an image that is determined to have high similarity to the captured image as a result of image retrieval based on the captured image from the retrieval terminal 30. The history managing unit 18 acquires a campaign ID of the campaign 70 that includes this acquired image identification information, from the campaign information DB 16. The history managing unit 18 stores the acquired campaign ID, the terminal identification information to identify the retrieval terminal 30, and date of data retrieval in the history DB 17 in an associated manner. The terminal identification information is acquired by the communication unit 102, for example, when the communication unit 102 communicates with the retrieval terminal 30.

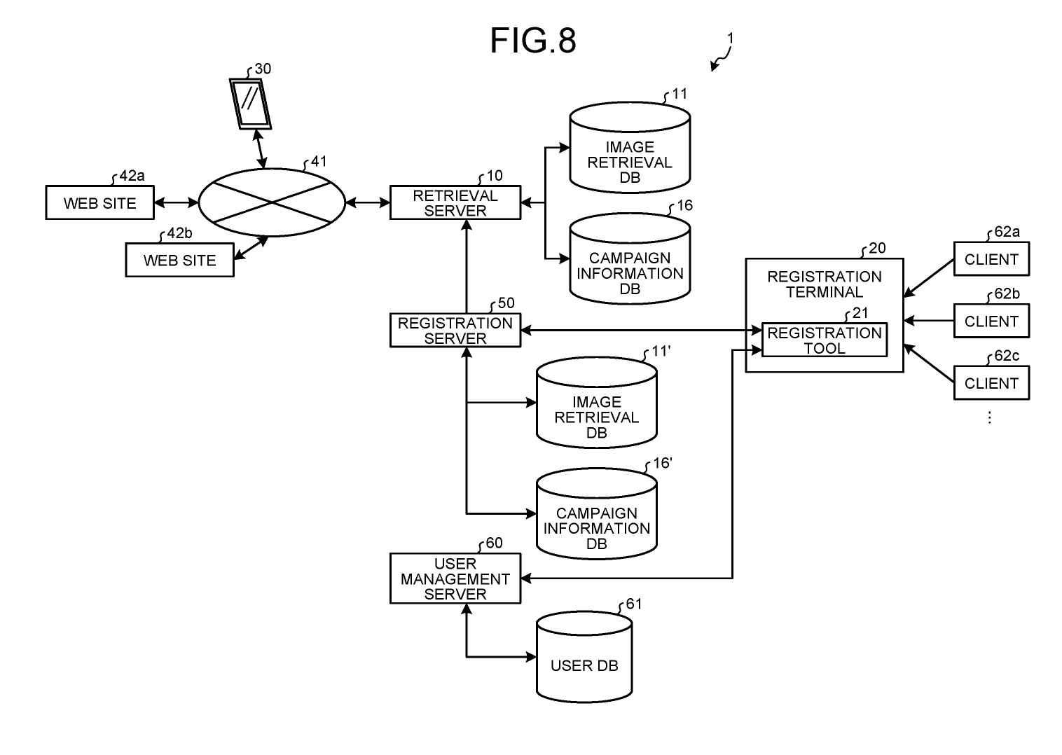

FIG. 8 schematically shows a configuration of one example of the information processing system according to the embodiment. In FIG. 8, common reference numerals are assigned to components common with FIG. 1 and FIG. 2 described above, and detailed explanation is omitted.

In FIG. 8, the information processing system 1 includes the retrieval server 10, the registration terminal 20, and a registration server 50. The information processing system 1 may further include a user management server 60. In FIG. 8, the image retrieval DB 11 and the campaign information DB 16 are illustrated as connected externally to the retrieval server 10 for explanation's sake.

The retrieval server 10 analyzes an image (captured image) that is transmitted from the retrieval terminal 30 through the Internet 41 to extract feature information, and the retrieving unit 13 retrieves feature information that is similar to the extracted feature information from the image DB 14. The retrieval server 10 acquires association information that corresponds to image identification information associated with the feature information retrieved from the image DB 14, from the association information DB 15, and transmits the acquired association information to the retrieval terminal 30.

The registration server 50 includes an image retrieval DB 11′ corresponding to the image retrieval DB 11, and has the image retrieving unit 100 including the analyzing unit 12 and the retrieving unit 13, similarly to the retrieval server 10. Furthermore, the registration server 50 includes a campaign information DB 16′ corresponding to the campaign information DB 16.

The registration terminal 20 includes a registration tool 21. The registration terminal 20 is provided with an image and association information to be associated with the image by each of clients 62a, 62b, 62c, . . . . The registration terminal 20 associates each of the images provided by the clients 62a, 62b, 62c, . . . with the association information, and transmits the associated images to the registration server 50. Moreover, the registration terminal 20 adds a campaign ID to each of the images provided by the clients 62a, 62b, 62c, . . . , and creates campaign information of the campaign 70, associating the metadata 72 and the related campaign information 73 with the campaign ID. The registration terminal 20 transmits the created campaign information to the registration server 50.

This processing of transmitting images provided by the clients 62a, 62b, 62c, . . . to the registration server 50, associating with association information, and processing of creating campaign information by adding the metadata 72 and the related campaign information 73 in associated manner to the images to transmit to the registration server 50 are performed by the registration tool 21 in the registration terminal 20.

The registration server 50 registers the image and the association information transmitted from the registration terminal 20 in the image retrieval DB 11′. That is, the registration server 50 analyzes the image transmitted from the registration terminal 20 by the analyzing unit 12 included in the registration server 50, and extracts feature information that expresses features of the image, from the image. The registration server 50 stores the extracted feature information associating with the image identification information in the image DB 14 included in the image retrieval DB 11′, and stores association information corresponding to the image stored in the image DB 14 in the association information DB 15 associating with the image identification information, and registers the image in the image retrieval DB 11′. The registration server 50 registers the campaign information transmitted from the registration terminal 20 in the campaign information DB 16′.

At registration of an image to the registration server 50, the registration terminal 20 can perform similar image checking that checks whether an image similar to the image to be registered has already been registered in the registration server 50.

For example, the registration terminal 20 transmits, to the registration server 50, an image wished to be checked whether a similar image has already been registered. The registration server 50 analyzes, in response to this request, the image transmitted from the registration terminal 20 to extract feature information, searches, based on the extracted feature information, the image DB 14 in the image retrieval DB 11′ by the retrieving unit 13, and transmits a search result to the registration terminal 20. The registration terminal 20 presents, for example, a message indicating the search result transmitted from the registration server 50, for example, by displaying on a display. Based on this message, it is possible to know whether an image similar to the image to be checked has already been registered in the image retrieval DB 11′, and change or correction of the image can be performed according to the result.

The registration server 50 transmits an image set to be releasable to the public and association information from among images (feature information) registered in the image retrieval DB 11′ and association information, to the retrieval server 10, and causes the retrieval server 10 to register the releasable image and association information in the image retrieval DB 11. For example, the registration server 50 communicates with the retrieval server 10 at predetermine time such as at night time, and retrieves an image that is set to be releasable to the public and that has not been registered in the image retrieval DB 11 of the retrieval server 10, out of images registered in the image retrieval server 11′ of the registration server 50. The registration server 50 transmits the retrieved image and association information associated with the image, to the retrieval server 10. The retrieval server 10 registers the image and the association information transmitted from the registration server 50 in the image retrieval DB 11.

Moreover, the registration server 50 transmits an image and association information registered in the image retrieval DB 11′, and transmits campaign information registered in the campaign information DB 16′ to the retrieval server 10, and causes the retrieval server 10 to register the transmitted information in the campaign information DB 16.

The user management server 60 includes a user DB 61, and manages information of a user that uses the information processing system 1. For example, the user DB 61 registers information of the clients 62a, 62b, 62c, . . . , information of a user that can use a function of the registration terminal 20 (registration tool 21), and information of an administrator that administrates the retrieval server 10 and the registration server 50.

The user management server 60 manages user information, for example, in four levels of hierarchy: an overall administrator, a domain administrator, a client administrator, and a client. The overall administrator has the authority being able to access to information of the domain administrator, the client administrator, and the client. The client administrator has the authority being able to access to the information of the client administrator and the client. The client administrator has the authority being able to access to the information of the client. The client can access only to own information of each client. Each information registered in the user DB 61 can be viewed and edited using the registration tool 21 from the registration terminal 20 according to the authority given to each level of hierarchy.

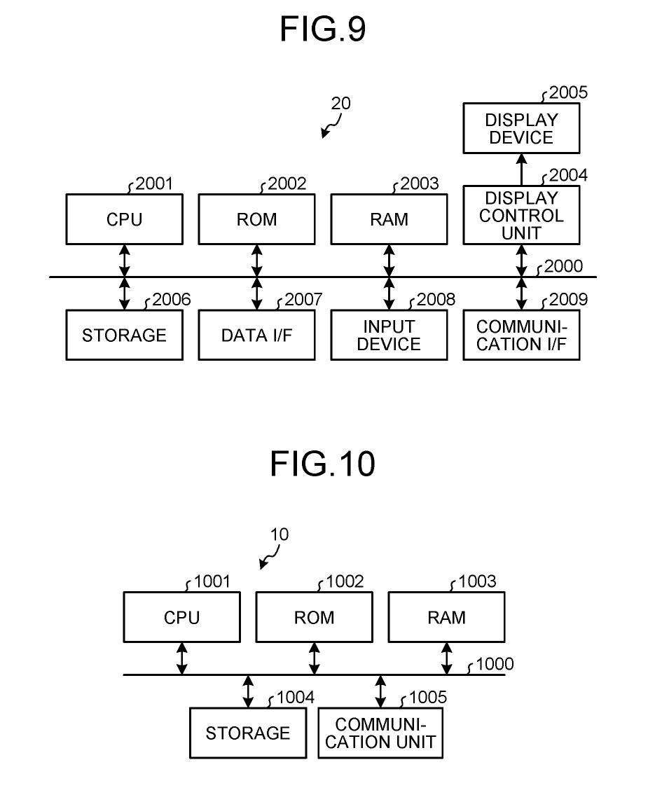

FIG. 9 illustrates a configuration of one example of hardware of the registration terminal 20 applicable to the embodiment. In the registration terminal 20 illustrated in FIG. 9, a central processing unit (CPU) 2001, a read only memory (ROM) 2002, a random access memory (RAM) 2003, and a display control unit 2004 are connected to a bus 2000. Furthermore, to the bus 2000, a storage 2006, a data interface (I/F) 2007, an input device 2008, and a communication I/F 2009 are connected.

The storage 2006 is a recording medium that can store therein data in a nonvolatile manner, and, for example, a hard disk drive is used as the storage 2006. It is not limited to this, a nonvolatile semiconductor memory, such as a flash memory, may be used as the storage 2006. The storage 2006 stores therein a program to be executed by the CPU 2001 and various kinds of data.

The CPU 2001 controls the entire registration terminal 20 according to a program stored in the ROM 2002 and the storage 2006, by using the RAM 2003 as a work memory.

The display control unit 2004 converts a display control signal that is generated by the CPU 2001 into a signal enabled to be displayed by the display device 2005 and output the signal. The display control unit 2004 drives the display device 2005 based on the display control signal generated by the CPU 2001. The display device 2005 is driven by the display control unit 2004 and performs display in accordance with the display control signal.

The data I/F 2007 performs input/output of data with respect to an external device. As the data I/F 2007, for example, an interface such as a universal serial bus (USB) and Bluetooth (registered trademark) can be applied. The communication I/F 2009 performs wireless communication through a network in accordance with control of the CPU 2001.

The input device 2008 includes, for example, a pointing device such as a mouse and a keyboard, and accepts a user input. A user can give an instruction to the registration terminal 20 by operating the input device 2008, for example, according to a display on the display device 2005.

FIG. 10 shows a configuration of one example of hardware applicable to the retrieval server 10 according to the embodiment. As shown in FIG. 10, in the retrieval server 10, the CPU 1001, a ROM 1002, a RAM 1003, a storage 1004, and a communication unit 1005 are connected to a bus 1000. The storage 1004 is a recording medium that can store therein data in a nonvolatile manner, and, for example, a hard disk drive is used as the storage 1004. It is not limited to this, a nonvolatile semiconductor memory, such as a flash memory, may be used as the storage 1004.

The CPU 1001 controls the entire retrieval server 10 according to a program stored in the ROM 1002 and the storage 1004, using the RAM 1003 as a work memory.

The storage 1004 stores a program to be executed by the CPU 1001 and various kinds of data. The image retrieval DB 11, the campaign information DB 16, and the history DB 17 described above are configured using a storage area in this storage 1004. Although FIG. 10 illustrates the storage 1004 as configured with one unit of hardware, it is not limited to this example, and multiple units of storage devices may be managed, for example, as a single unit of the storage 1004 integrally.

The communication unit 1005 includes a communication I/F that performs wireless communication through a network in accordance with a control by the CPU 1001.

Although FIG. 10 illustrates the retrieval server 10 as configured with one unit of hardware, it is not limited to this example, but the retrieval server 10 may be configured with multiple units of server devices having an equivalent configuration controlled integrally. The registration server 50 can be implemented by the same configuration as the retrieval server 10, and therefore, explanation thereof is omitted herein.

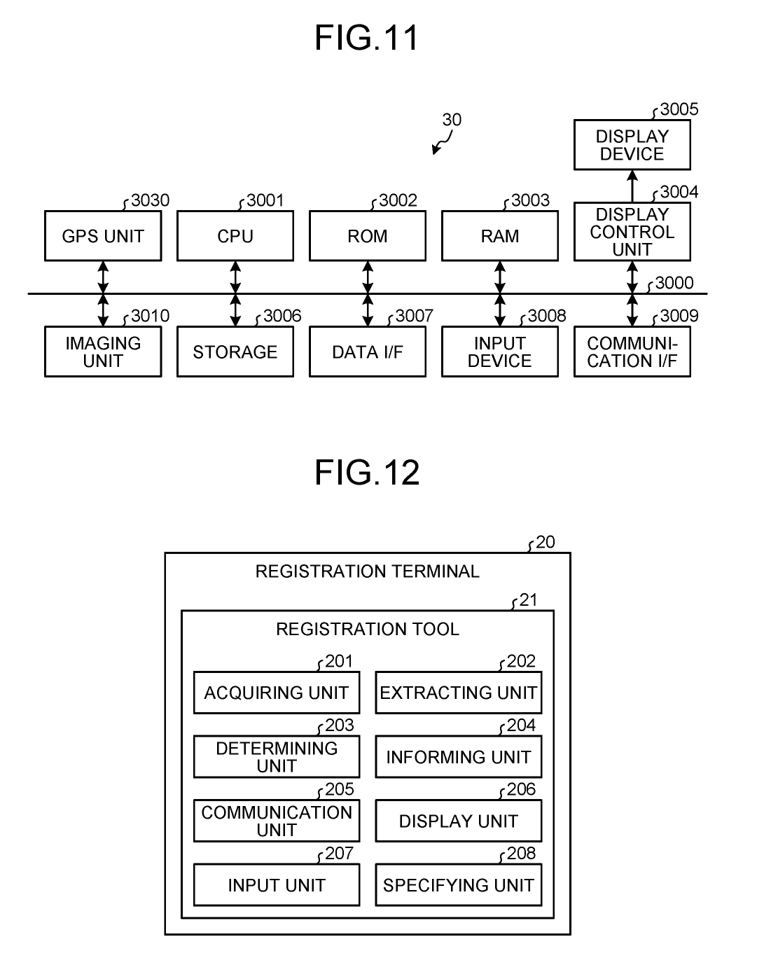

FIG. 11 shows a configuration of one example of hardware of the retrieval terminal 30 applicable to the embodiment. In the retrieval terminal 30 illustrated in FIG. 11, a CPU 3001, a ROM 3002, a RAM 3003, and a display control unit 3004 are connected to a bus 3000. Furthermore, a storage 3006, a data I/F 3007, an input device 3008, a communication I/F 3009, an imaging unit 3010, and a global positioning system (GPS) unit 3030 are connected to the bus 3000.

The storage 3006 is a recording medium that can store data in a nonvolatile manner, and is, for example, a semiconductor memory such as a nonvolatile flash memory. It is not limited to this, a hard disk drive may be used as the storage 3006. The storage 3006 stores therein a program to be executed by the CPU 3001 and various kinds of data. The storage 3006 and the ROM 3002 may use, for example, a single unit of rewritable nonvolatile semiconductor memory in a shared manner.

The CPU 3001 controls the entire retrieval terminal 30 according to a program stored in the ROM 3002 and the storage 3006, by using the RAM 3003 as a work memory. The display control unit 3004 converts a display control signal that is generated by the CPU 3001 into a signal enabled to be displayed by the display device 3005 and outputs the signal.

The data I/F 3007 performs input/output of data with respect to an external device. As the data I/F 3007, for example, an interface such as a universal serial bus (USB) and Bluetooth (registered trademark) can be applied.

The display control unit 3004 drives the display device 3005 based on the display control signal generated by the CPU 3001. The display device 3005 includes, for example, a liquid crystal display (LCD), and is driven by the display control unit 3004 and performs display in accordance with the display control signal.

The input device 3008 accepts a user input. A user can give an instruction to the retrieval terminal 30 by operating the input device 3008, for example, according to a display on the display device 3005. In addition, it is preferable to integrate the input device 3008 and the display device 3005 to a single device: a touch panel that outputs a control signal according to a pressed position and that displays an image of the display device 300 to be seen through the input device 3008.

The communication I/F 3009 performs wireless communication through a network in accordance with control of the CPU 3001.

The imaging unit 3010 includes an optical system, an imaging device, and a control/drive circuit of the optical system and the imaging device, and subjects an imaging signal output from the imaging device to predetermined processing to output as an imaging signal of a digital signal. The imaging unit 3010 performs functions such as imaging and zooming in accordance with an instruction given by a user operation made to the input device 3008. A captured image output from the imaging unit 3010 is transmitted to the CPU 3001 through the bus 3000, and is subjected to predetermined image processing according to a program. The captured image output from the imaging unit 3010 and subjected to the image processing can be stored, for example, in the storage 3006. Moreover, the CPU 3001 can read the captured image from the storage 3006 and transmit the read image to a network by the communication I/F 3009.

The GPS unit 3030 receives a signal by the GPS, and calculates a current position of degrees of latitude and longitude based on the received signal.

FIG. 12 is a functional block diagram of one example for explaining a function of the registration terminal 20 according to the embodiment. The registration terminal 20 includes the registration tool 21, and the registration tool 21 includes an acquiring unit 201, an extracting unit 202, a determining unit 203, an informing unit 204, a communication unit 205, a display unit 206, an input unit 207, and a specifying unit 208.

The acquiring unit 201, the extracting unit 202, the determining unit 203, the informing unit 204, the communication unit 205, the display unit 206, the input unit 207, and the specifying unit 208 are implemented by a program operating on the CPU 2001. It is not limited to this, a part or all of these components may be configured with pieces of hardware that operate collaboratively with each other.

The communication unit 205 controls communication through a network, and functions as a transmitting unit that transmit data to the network, and a receiving unit that receives data from the network.

The display unit 206 generates display information to be displayed on the display device 2005. That is, in the registration terminal 20, the CPU 2001 generates a display control signal based on the display information generated by the display unit 206, and transfers the generated display control signal to the display control unit 2004. The display control unit 2004 causes the display device 2005 to perform display in accordance with this display control signal. In the following, a series of actions in which display on the display device 2005 is performed according to the display information generated by the display unit 206 is described such as the display unit 206 performs display, and the like.

The input unit 207 accepts information input by an input operation made to the input device 2008. For example, the input unit 207 accepts information that is input to each item included in the metadata 72. The specifying unit 208 specifies, to campaign information accepted by the input unit 207, another related campaign to be associated with the campaign 70 that is indicated by the campaign information.

The acquiring unit 201 acquires externally an image out of the registration terminal 20. The acquiring unit 201 acquires an image, for example from the client 62a. The acquiring unit 201 may acquire an image that is transmitted from other devices included in the client 62a through a network, or may receive an image through a recording medium such as a compact disk (CD) and a digital versatile disk (DVD). Furthermore, the acquiring unit 201 may acquire an image from a print medium such as paper. Furthermore, the acquiring unit 201 acquires information for association information to be associated with the image from the client 62a.

The extracting unit 202 extracts an image of a predetermined region in the image acquired by the acquiring unit 201. The determining unit 203 determines whether an image similar to an image to be registered in the registration server 50 partially or entirely has already been registered in the registration server 50. The informing unit 204 informs information that indicates a result of determination made by the determining unit 203.

For example, the registration terminal 20 is equipped with a browser application (hereinafter, browser) that is equivalent to one equipped in a general computer. The browser operates on the CPU 2001, reads a file described, for example, in a hypertext markup language (HTML), and performs predetermined operations. In the registration terminal 20, information processing program in the registration server 50 is read onto the browser by accessing to the registration server 50 using the browser.

The information processing program has a module structure, for example, including the respective components described above (the acquiring unit 201, the extracting unit 202, the determining unit 203, the informing unit 204, the communication unit 205, the display unit 206, the input unit 207, and the specifying unit 208). As actual hardware, by executing the information processing program read from the registration server 50 by the browser operating on the CPU 2001, the above respective components are loaded on a main storage device (for example, the RAM 2003), to create the respective components on the main storage device.

It is not limited to this, the information processing program may be stored, for example, in the storage 2006 in advance to be provided. Moreover, this information processing program can be configured to be stored in a computer connected to a network, and to be provided by downloading the program through the network by the communication I/F 2009. Alternatively, this information processing program may be configured to be provided or distributed through a network.

It is not limited to this, the information processing program may be recorded in a non-transitory computer-readable recording medium, such as a CD and a DVD, in a file in an installable format or an executable format to be provided. In this case, the information processing program recorded in the recording medium is provided to the registration terminal 20, for example, through an external drive device that is connected to the data I/F 2007. It is not limited to this, the information processing program recorded in the recording medium may be temporarily stored in another information processing apparatus such as a personal computer, and be provided to the registration terminal 20 by communication through the communication I/F 2009 or the data I/F 2007 from this information processing apparatus.

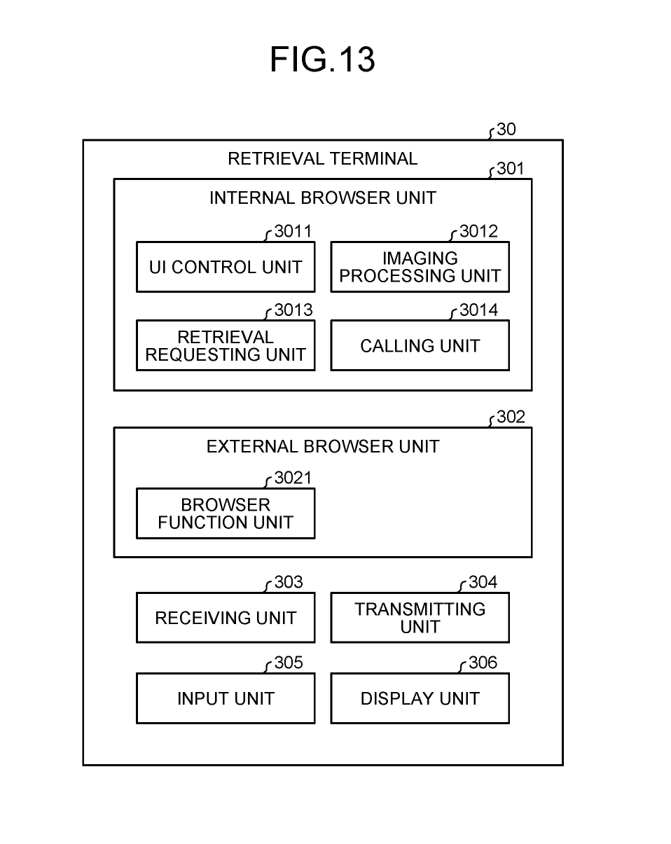

FIG. 13 is a functional block diagram of one example for explaining a function of the retrieval terminal 30 applicable to the embodiment. As shown in FIG. 13, the retrieval terminal 30 includes an internal browser unit 301, an external browser unit 302, a receiving unit 303, a transmitting unit 304, an input unit 305, and a display unit 306. The receiving unit 303, the transmitting unit 304, the input unit 305, and the display unit 306 are used by the internal browser 301 and the external browser 302 in a shared manner.

The receiving unit 303 performs reception processing of data that is transmitted through a network. The transmitting unit 304 performs transmission processing of data through a network. The input unit 305 accepts an input operation to the input device 3008 included in the retrieval terminal 30, and acquires data according to the operation. The display unit 306 controls display of information to the display device 3005 included in the retrieval terminal 30. The input unit 305 and the display unit 306 constitute a user interface of the retrieval terminal 30.

The internal browser 301 includes a user interface (UI) control unit 3011, an imaging processing unit 3012, a retrieval requesting unit 3013, and a calling unit 3014. The internal browser unit 301 implements a function corresponding to the information processing system 1, and is a retrieval application program that executes image retrieval by the retrieval server 10 in the information processing system 1. Hereinafter, this retrieval application program is called “retrieval app” for short.

The UI control unit 3011 controls each component (the imaging processing unit 3012, the retrieval requesting unit 3013, and the calling unit 3014) in the internal browser unit 301 and controls a user interface by the internal browser unit 301. That is, the UI control unit 3011 generates display information to be displayed on the display device 3005 and transfers the information to the display unit 306. Moreover, the UI control unit 3011 performs processing according to an input operation that is accepted by the input unit 305 according to display by the display unit 306.

The imaging processing unit 3012 controls the imaging unit 3010 by activating a camera function of the retrieval terminal 30 in accordance with control by the UI control unit 3011, to output a captured image. The retrieval requesting unit 3013 generates a retrieval request to request retrieval based on the captured image acquired by the imaging processing unit 3012, in accordance with control by the UI control unit 3011, and transmits the generated retrieval request and the capture image to the retrieval server 10 from the transmitting unit 304. The calling unit 3014 calls the external browser unit 302 in accordance with control by the UI control unit 3011, to cause a function of the external browser unit 302 to be performed.

The external browser unit 302 includes a browser function unit 3021. The browser function unit 3021 is a browser application equivalent to one that is equipped in a general computer, and reads a file described, for example, in HTML, and performs predetermined display.

These components of the internal browser 301, the external browser 302, the receiving unit 303, the transmitting unit 304, the input unit 305, and the display unit 306 are implemented by a program operating on the CPU 3001. It is not limited to this, a part or all of the internal browser 301, the external browser unit 302, the receiving unit 303, the transmitting unit 304, the input unit 305, and the display unit 306 may be implemented by pieces of hardware that operate collaboratively with each other.

The retrieval terminal 30 may include various functions in addition to the internal browser unit 301 and the external browser 302 described above. For example, the retrieval terminal 30 may include a telephone function and an email function. Moreover, the retrieval terminal 30 may further include a video reproduction function that dedicatedly supports a video distribution service provided on a predetermined web site on the Internet 41.

The internal browser 301, the external browser 302, the receiving unit 303, the transmitting unit 304, the input unit 305, and the display unit 306 included in the retrieval terminal 30 described above are implemented by programs operating on the CPU 3001. Out of these programs, ones corresponding to the external browser unit 302, the receiving unit 303, the transmitting unit 304, the input unit 305, and the display unit 306 are stored, for example, in the storage 3006 in advance to be provided.

Furthermore, out of these programs, an internal browser program to implement the internal browser unit 301 can be configured to be stored in a computer that is connected to a network, and to be provided by being downloaded through the network by the communication I/F 3009. Alternatively, this internal browser program may be configured to be provided or distributed through a network.

It is not limited to this, the internal browser program may be recorded on a non-transitory computer-readable recording medium, such as a CD and a DVD, in a file in an installable format or in an executable format to be provided. In this case, the internal browser program recorded in the recording medium is provided to the retrieval terminal 30, for example, through an external drive device that is connected to the data I/F 3007. It is not limited to this, the internal browser program recorded in the recording medium may be temporarily stored in another information processing apparatus such as a personal computer, and be provided to the retrieval terminal 30 by communication through the communication I/F 3009 or the data I/F 3007 from this information processing apparatus.

The internal browser program has a module structure, for example, including the respective components described above (the UI control unit 3011, the imaging processing unit 3012, the retrieval requesting unit 3013, and the calling unit 3014), and becomes operable as a retrieval app when installed into the retrieval terminal 30.

The internal browser program is configured such that, the CPU 3001 as actual hardware reads the internal browser program from, for example, the storage 3006 to execute the program, thereby the above respective components are loaded on a main storage device (for example, the RAM 3003) to create the respective components on the main storage device.

Moreover, an app ID that is identification information unique to installation of the internal browser program is assigned thereto when the internal browser program is supplied, provided, or distributed as described above and installed in the retrieval terminal 30. For example, when installation of the internal browser program to the retrieval terminal 30 is completed, accessing a specific server through a network, completion of installation is notified to this specific server.

The specific server creates a unique app ID in response to the notification of completion of installation from the retrieval terminal 30. The app ID may be created by using a random number, or by using controlled information such as a serial number. The specific server transmits the created app ID to the retrieval terminal 30 that is the origin of the notification of completion of installation. The retrieval terminal 30 receives the app ID transmitted from the specific server, and the internal browser unit 301 invisibly stores the received app ID, for example, in the storage 3006.

As the app ID is identification information unique to installation of the retrieval app (internal browser program), it is substantially the same meaning as identification information unique to the retrieval terminal 30.

Image Registration Processing According to Embodiment

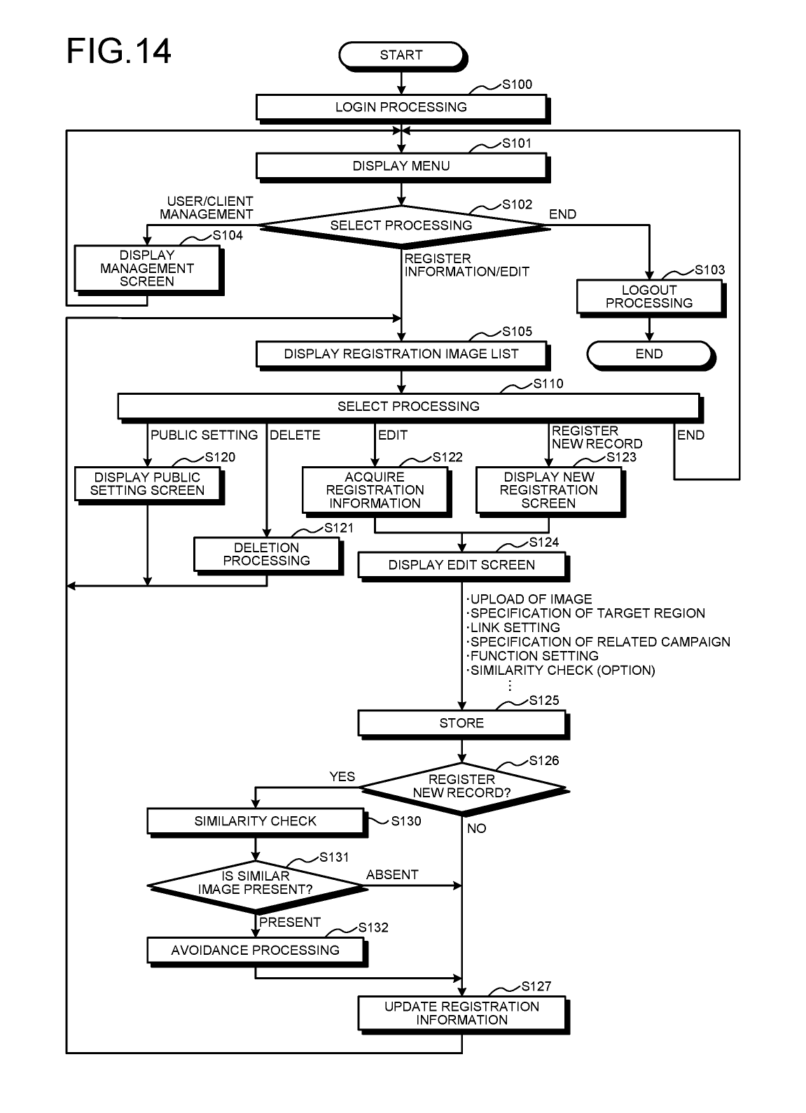

Next, image registration processing according to the embodiment is explained. FIG. 14 is a flowchart illustrating one example of the image registration processing that is performed by the registration tool 21 in the registration terminal 20 according to the embodiment. It is assumed that information of a user (a user ID and a password) that uses the registration tool 21 is registered in the user DB 61 by the user management server 60 prior to the processing in the flowchart shown in FIG. 14. Moreover, it is assumed that images are registered per campaign in the following.

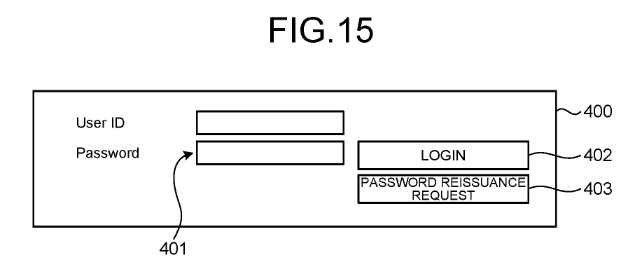

When the registration tool 21 is activated in the registration terminal 20, at step S100, the registration tool 21 performs login processing for a user. For example, the registration tool 21 displays a login screen 400 shown in FIG. 15 on the display unit 206. In the example shown in FIG. 15, the login screen 400 includes an input unit 401 to input user information (a user ID and a password), a button 402 to instruct login, and a button 403 to request reissuance of a password arranged therein.

For example, when a user ID and a password are input to the input unit 401, the registration tool 21 transmits the input user ID and password to the user management server 60, and requests authentication of the user ID. The registration tool 21 shifts the processing to step S101 when information indicating that the authentication of the user ID is successful is received from the user management server 60.

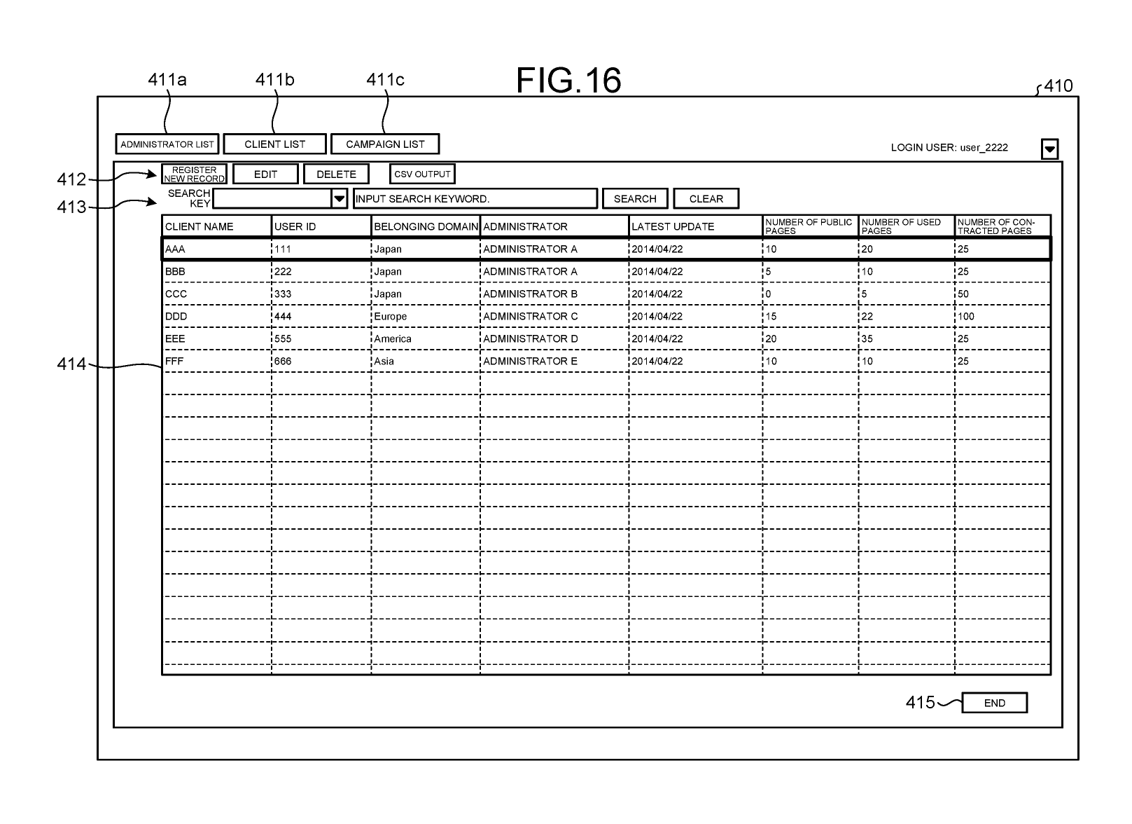

At step S101, the registration tool 21 displays a menu screen 410 shown in FIG. 16 on the display unit 206. In the example illustrated in FIG. 16, the menu screen 410 includes tabs 411a, 411b, and 411c, a button group 412, a search-key input portion 413, a list display area 414, and an end button 415 arranged therein.

The tabs 411a, 411b, and 411c are tabs to determine an operation mode of the registration tool 21 by selecting a menu item. The tabs 411a and 411b are tabs to transition to a user management mode, and when operated, an administrator list and a client list are respectively displayed. Moreover, the tab 411c is a tab to transition to an image registration mode, and a campaign list is displayed when operated.

In the list display area 414, a list corresponding to a menu item that is selected by the tabs 411a, 411b, and 411c is displayed. In the example shown in FIG. 16, the tab 411b is operated, and the client list is selected. In the following, each row of the list is called record, and each column of the list is called item.

The button group 412 selects processing to be performed on a list displayed in the list display area 414. In the example shown in FIG. 16, the button group 412 includes four buttons, and each of the buttons is allocated to functions of “register new record”, “edit”, “delete”, and “CSV output”, respectively, from the left. With the “register new record” button, a record is newly added to a list displayed in the list display area 414. With the “edit” button, information of a record that is selected in a list displayed in the list display area 414 is edited. With the “delete” button, information of a record that is selected in a list displayed in the list display area 414 is deleted. With the “CSV output” button, information of a list displayed in the list display area 414 is output in a text file in a comma-separated values (CSV) format.

At the search-key input portion 413, it is selected a record from a list displayed in the list display area 414 based on a selected search key or an input search keyword. The end button 415 is to end the processing performed by the registration tool 21.

Returning to explanation of FIG. 14, when a menu is displayed at step S101, the processing is proceeded to following step S102, and the registration tool 21 becomes standby until a next process is selected by operating either one of the tabs 411a, 411b, and 411c, and the end button 415. Alternatively, when the end button 415 is operated, the registration tool 21 shifts the process to step S103, and performs logout processing for the user, and ends the operation of the registration tool 21.

Moreover, at step S102, when the tab 411a or the tab 411b is operated to select the user management mode, the registration tool 21 shifts the process to step S104. The registration tool 21 displays, at step S104, either the administrator list screen or the client list screen depending on either one of the tabs 411a and 411b is selected at step S102. The registration tool 21 returns the process to step S101 and displays the menu when it is operated that the process on the administrator list screen or the client list screen is completed.

Furthermore, when the tab 411c is operated to select the image registration mode at step S102, the registration tool 21 shifts the process to step S105. At step S105, the registration tool 21 displays a registration-information list screen 420 as shown in FIG. 17 on the display unit 206, and waits for a user operation. In the example shown in FIG. 17, the registration-information list screen 420 includes and arranges therein buttons 421a to 421d, a search-key input portion 422, a list display area 423, and an end button 424.

In the list display area 423, it is displayed a list of campaign that is registered in the registration server 50. At this time, the registration tool 21 can select a campaign accessible for a user that has logged in to the registration tool 21 out of campaigns registered in the registration server 50, and can display the campaign in the list display area 423. For example, the registration tool 21 acquires information about a logged-in user from the user management server 60, and based on this information, acquires a list of campaign accessible for the user from the campaign information DB 16′ of the registration server 50.

The button 421a is a “register new record” button to add a record newly to a list displayed in the list display area 423. The button 421b is an “edit” button to edit information of a record that is selected in a list displayed in the list display area 423. The button 421c is a “delete” button to delete information of a record that is selected in a list displayed in the list display area 423. Moreover, the button 421d is a button to set whether a campaign registered in a record that is selected in a list displayed in the list display area 423 is to be released to the public or not released to the public.

In the example shown in FIG. 17, in a list displayed in the list display area 423, each record includes respective items of “campaign ID”, “campaign name”, “client name”, “user ID”, “person in charge”, “number of public pages (released pages)”, “number of used pages”, “latest update”, “state”, “administrator”, “belonging domain”, “related campaign”, and “CSV output”. Information of a record includes the metadata 72 of the campaign 70 indicated in the record and the related campaign information 73, and is stored, for example, in the campaign information DB 16′ in the registration server 50.

In each record of a list displayed in the list display area 423, the item “campaign name” indicates a name given to a campaign that is registered in the record. The item “client name” indicates an owner of a campaign of the record. The item “user ID” indicates an ID of the owner of the campaign of the record. The item “person in charge” indicates a user name of a user that has input the information of the campaign of the record.

The item “number of public pages” indicates the number of pages set to be released to the public, out of pages included in the campaign of the record. For example, a page in which a target region described later is specified is to be a public page. The item “number of used pages” indicates the number of entire pages included in the campaign of the record. That is, the number of pages indicated in the item “number of used pages” is displayed even when the campaign of the record is not released to the public. When the item “number of public pages” and “number of used pages” are both “0”, it is indicated that only registration of campaign information has been done but registration of an image has not been done.

The item “latest update” indicates date of the latest edit of the campaign of the record. The item “state” indicates that the campaign of the record is either in a public state or in a non-public state. The item “administrator” indicates an administrator superior to the user in charge of the campaign of the record. The item “belonging domain” indicates information of a domain to which the item “administrator” belongs. Moreover, the item “CSV output” outputs information of the record in a text file in a CSV format. Items included in a record are not limited to these. Other items such as “remarks” in which arbitrary information can be input may be further included in a record.

When the registration-information list screen 420 is displayed at step S105, the registration tool 21 shifts the process to following step S110, and waits for an operation made to the buttons 421a to 421d and the end button 424. In the following, processes according to operations to each of the buttons are explained following items (1) to (5) below.

(1) At step S110, when the button 424 that instructs to end the process operated, the registration tool 21 returns the process, for example, to step S101 and displays the menu.

(2) At step S110, when the button 421d that sets a campaign to be released to the public or not released to the public is operated while a record is selected in the list display area 423, the registration tool 21 shifts the process to step S120. At step S120, the registration tool 21 displays, on the display unit 206, a public setting screen at which public or non-public of the campaign indicated in the selected record is set.

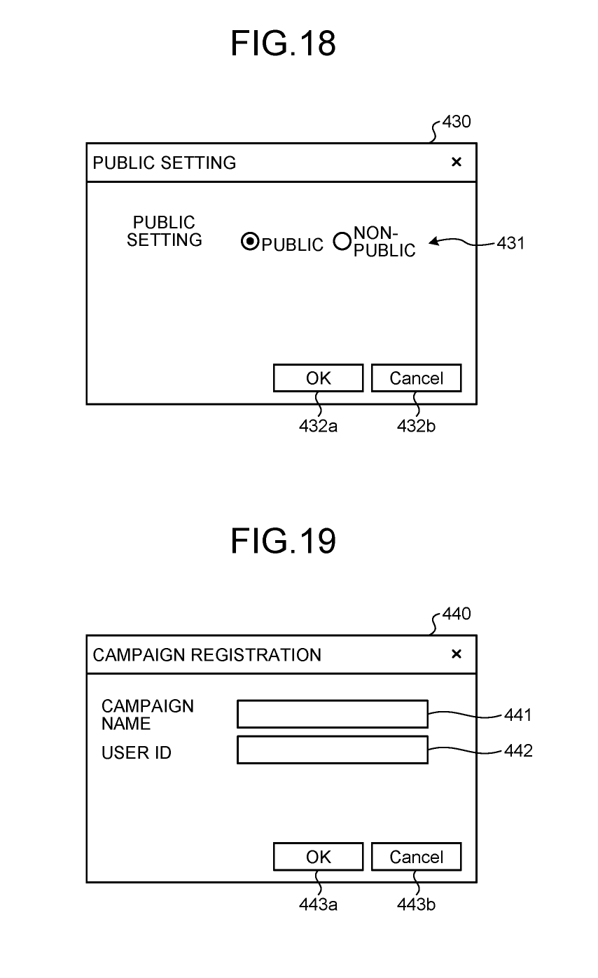

FIG. 18 shows one example of a public setting screen applicable to the embodiment. In the example shown in FIG. 18, a public setting screen 430 includes and arranges therein a public setting portion 431, an OK button 432a, and a cancel button 432b. In the example shown in FIG. 18, at the public setting portion 431, it can be set to be released to the public or not released to the public exclusively by operating a radio button. A value of the item “state” of the selected record is the initial value. The registration tool 21 sets, when the OK button 432a is operated, a public state that has been set to be released to the public or not released to the public by the public setting unit 431 to the record. The registration tool 21 updates a display of the list display area 423 when the public state is set, and returns the process to step S105. Moreover, when the cancel button 432b is operated, the registration tool 21 sets the public state of the record to a state before display of the public setting screen 430, and returns the process to step S105.

(3) At step S110, when the button 421c that instructs deletion of an image is operated while a record is selected in the list display area 423, the registration tool 21 shifts the processing to step S121. The registration tool 21 deletes the selected record at step S121. At this time, it is preferable that the registration tool 21 displays a confirmation screen to confirm whether to delete a record including information of an image associated with the record. The registration tool 21 updates the display in the list display area 423 when the record is deleted, and returns the processing to step S105.

(4) At step S110, when the button 421b that instructs edit of an image is operated, the registration tool 21 shifts the process to step S122. At step S122, the registration tool 21 acquires, from the registration server 50, an image included in a campaign indicated in a record that is selected in a list displayed in the list display area 423 of the registration-information list screen 420. when association information is associated with the acquired image, the registration tool 21 also acquires the association information. The registration tool 21 then shifts the process to step S124.

(5) Furthermore, at step S110, when the button 421a that instructs new record registration is operated, the registration tool 21 shifts the process to step S123, and performs registration process of a new campaign. At step S123, the registration tool 21 first displays, on the display unit 206, a campaign registration screen 440 as shown in FIG. 19 to perform new record registration of a campaign.

In the example shown in FIG. 19, the campaign registration screen 440 includes and arranges therein input units 441 and 442 to input a campaign name and a user ID, an OK button 443a, and a cancel button 443b. A character string that is input to the input unit 441 is to be a value of the item “campaign name” of a record. Similarly, a character string that is input to the input unit 442 is to be a value of the item “user ID” of the record.

When the OK button 443a is operated, the registration tool 21 sets respective character strings that is input to the input units 441 and 442 as the items “campaign name” and the “user ID”, and shifts the process to step S124.

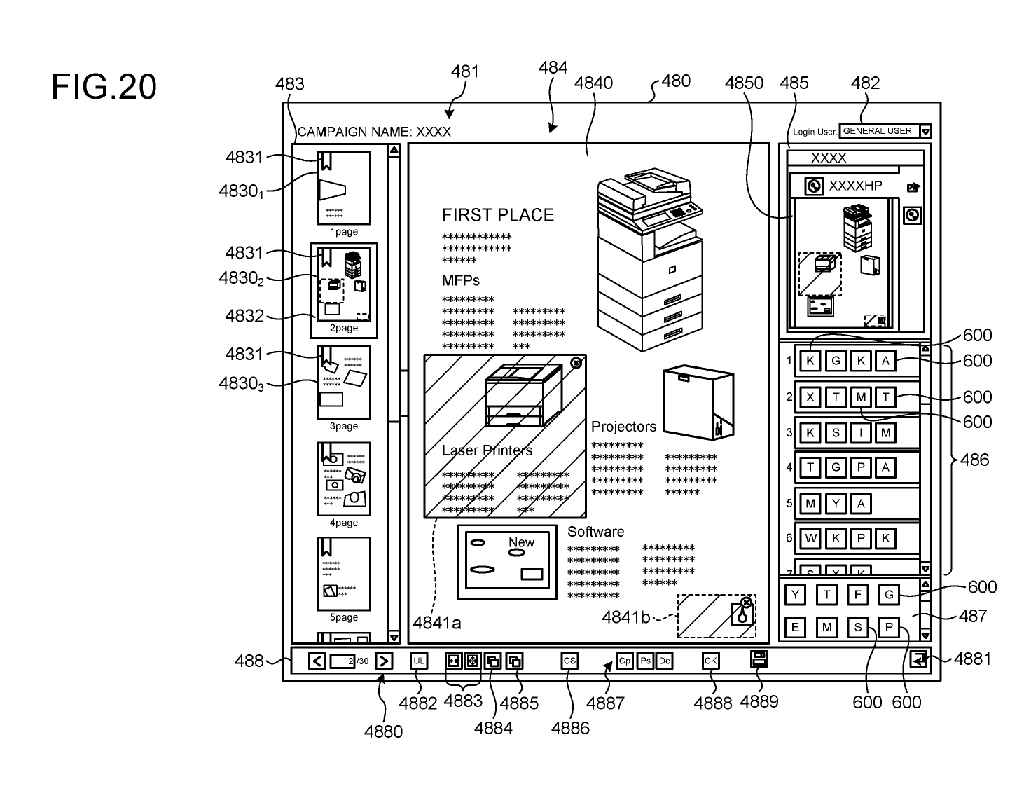

At step S124, the registration tool 21 displays, on the display unit 206, an edit screen that edits information of the campaign. FIG. 20 shows an example of the edit screen according to the embodiment. In the example shown in FIG. 20, an edit screen 480 includes a header area 481, a thumbnail display area 483, a page edit area 484, a preview area 485, a target-region list area 486, a link-icon list area 487, and a tool bar 488.

The header area 481 displays, on the left end thereof, a name of a campaign that is edited with the edit screen 480, and arranges, on the right end thereof, a user-menu display unit 482 at which displayed is a menus that can be used within the authority of a user who has logged into the registration tool 21.

The thumbnail display area 483 is an area in which thumbnail images, that are reduced images of respective images included in the campaign, are displayed. For example, when the process is proceeded from step S122 at which edit of campaign information described above is instructed to step S124, the registration tool 21 acquires, from the image DB 14 of the registration server 50, each image included in the campaign displayed in a record selected from the list display area 423 that is acquired from the registration server 50 at step S122. The registration tool 21 then creates thumbnail images by reducing the size of each of the acquired images, and displays the created thumbnail images in the thumbnail display area 483. In the example shown in FIG. 20, thumbnail images 4830₁, 4830₂, 4830₃, . . . are displayed in the thumbnail display area 483.

When the process is proceeded from step S123 at which it is instructed new registration of campaign information described above to step S124, the thumbnail display area 483 is to be blank. Moreover, by operating a scroll bar arranged on the right end of the thumbnail display area 483, other thumbnail images that are virtually displayed outside the thumbnail display area 483 can be sequentially displayed in the thumbnail display area 483.

In the page edit area 484, it is displayed an image 4840 that is an image to edited out of images included in the campaign. For example, the registration tool 21 displays an original image of a thumbnail that is selected from among the thumbnail images 4830₁, 4830₂, 4830₃, . . . displayed in the thumbnail display area 483, in the page edit area 484 as the image 4840. In the example shown in FIG. 20, the thumbnail image 4830₂ is selected in the thumbnail display area 483, and an original image of this selected thumbnail image 4830₂ is displayed in the page edit area 484 as the image 4840. Moreover, in the thumbnail display area 483, the thumbnail image 4830₂ is currently selected and displayed with being emphasized by a frame 4832 therearound.

When a range is specified in the image 4840 displayed in the page edit area 484, the registration tool 21 can set the specified range as a target region. Specifying the range is done with, for example, an operation of the input device 2008 made by a user accepted by the input unit 207. For example, by specifying arbitrary two points in the image 4840 that is displayed in the page edit area 484, a rectangular range having the specified two points as vertex on a diagonal line is specified. In the example shown in FIG. 20, target regions 4841a and 4841b are specified in rectangular ranges in the image 4840 in the page edit area 484.

The registration tool 21 can display the target regions 4841a and 4841b explicitly by displaying the set target regions 4841a and 4841b, for example, changing the color inside the regions from color of an area outside the regions. Moreover, the shape of a target region is not limited to a rectangular shape, but any closed shape can be applied.

The registration tool 21 generates identification information (a serial number and the like) that identifies each of the set target regions 4841a and 4841b, and associates the information with the target regions 4841a and 4841b. The identification information is created in such a manner that a target region can be identified through each image included in a campaign to be edited.

Furthermore, although details are described later, the registration tool 21 can associate one or more pieces of association information with the target regions 4841a and 4841b set in the page edit area 484.

Moreover, the registration tool 21 adds a marker image 4831 to a thumbnail image corresponding to an image for which any kind of edit, for example, specification of a target region, has been done and has not been saved, out of the thumbnail images 4830₁, 4830₂, 4830₃, . . . displayed in the thumbnail display area 483.

The preview area 485 displays a preview screen 4850 that is obtained by emulating a screen in which the image being edited in the page edit area 484 is displayed on the display device 3005 of the retrieval terminal 30 by the application program corresponding to the information processing system 1. The registration tool 21 displays each of the target regions 4841a and 4841b set in the page edit area 484 explicitly with an emphasized display and the like in the preview area 485. Moreover, the registration tool 21 displays information that indicates association information set to each of the target regions 4841a and 4841b in the preview area 485, associating with each of the target regions 4841a and 4841b.

In the target-region list area 486, a list of association information that is added to each of the target regions set to each image included in the campaign to be edited is displayed with icon images 600, 600, . . . . In the example shown in FIG. 20, the registration tool 21 displays the association information collectively per identification information (serial number) that is added to a corresponding target region, in the target-region list area 486. Moreover, in the target-region list area 486, by operating a scroll bar arranged on a right end, association information of other target regions that are virtually displayed outside of the target-region list area 486 can be sequentially displayed in the target-region list area 486.

In the link-icon list area 487, association information that can be set to a target region is displayed in a list using the icon images 600, 600, . . . corresponding to each of the association information. The registration tool 21 can associate association information corresponding to the icon images 600, 600, . . . by moving the icon image 600 displayed in the link-icon list area 487 by so-called drag and drop operation, to overlap on, for example the target region 4841a set in the page edit area 484. Furthermore, with a single target region, one or more pieces of association information can be associated. That is, the registration tool 21 functions as a selecting unit that selects association information to be associated with a target image.

In the link-icon list area 487, by operating the scroll bar arranged on a right end, the other icon images 600 that are virtually arranged outside of the link-icon list area 487 can be sequentially brought to appear in the link-icon list area 487.

When association information is associated with a target region, the icon image 600 indicating the association information associated therewith at a predetermined position in the target region. This is preferable because this makes it possible to know which association information is associated with the target region 4841a easily. Moreover, association of association information with a target region is reflected to display in the preview area 485.

The tool bar 488 includes a page specifying unit 4880 that specifies a page (image) to be displayed in the page edit area 484, and a button or a button group 4881 to 4889 that implements various functions included in the registration tool 21 arranged therein. The button 4881 is a button that returns the screen displayed from the edit screen 480 to the registration-information list screen 420.

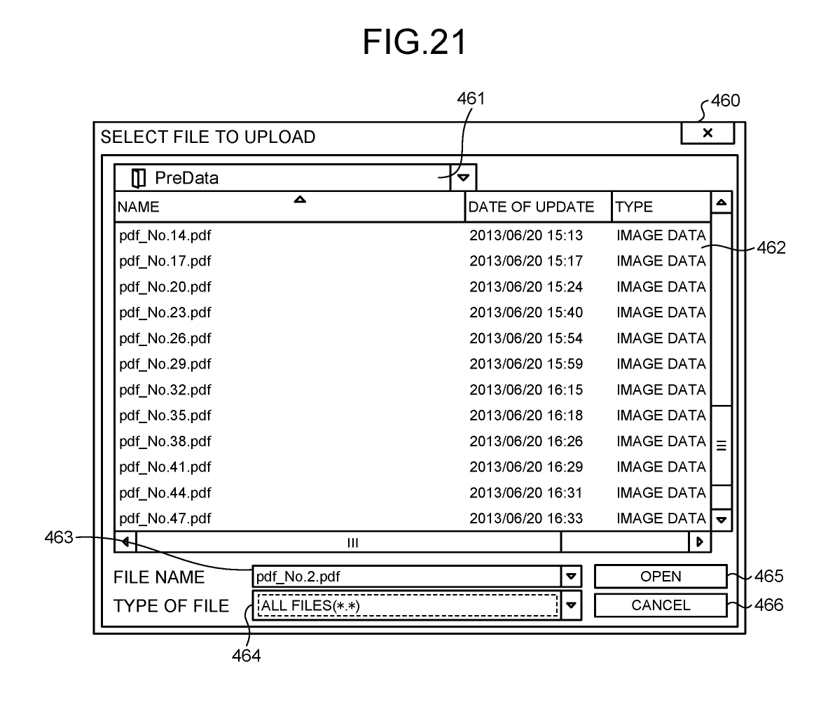

The button 4882 is a button that uploads an image to the registration server 50 from the registration terminal 20. When the button 4882 is operated, the registration tool 21 displays, for example, a file selecting screen 460 as shown in FIG. 21 on the display unit 206. In the example shown in FIG. 21, the file selecting screen 460 is a standard file selecting screen that is provided, for example, by an operating system (OS) that runs on the CPU 2001 of the registration terminal 20, and includes and arranges therein a folder specifying unit 461, a file-list display area 462, a file-name display unit 463, a file-format specifying unit 464, and buttons 365 and 366.

The file-list display area 462 displays a list of files that are stored in a folder specified by the folder specifying unit 461. The file-format specifying unit 464 specifies a format of a file to be displayed in the file-list display area 462. The file-name display unit 463 displays a file name of a file that is selected in the file-list display area 462. By selecting one or more files from among files displayed in the file-list display area 462 and operating the button 465, for example, information indicating the selected file is transferred to the registration tool 21 from the OS. The registration tool 21 transmits the file indicated in the file information transferred from the OS to the registration server 50 from the registration terminal 20, and uploads an image to the registration server 50. The button 466 is used when returning to the edit screen 480 without uploading a file.

Returning back to explanation of FIG. 20, the button group 4883 includes two buttons to adjust a display size of the image 4840 that is displayed in the page edit area 484.

The button 4884 switches a region setting mode to set a region in the page edit area 484 to a target region setting mode in which a target region setting is performed. When a region is specified in the image 4840 displayed in the page edit area 484, after the mode is switched to the target region setting mode from the edit mode by operating the button 4884, the registration tool 21 sets the region as a target region.

The button 4885 switches the region setting mode in which a region is specified in the page edit area 484 to a mask setting mode in which a mask region that is not to be a subject of extraction of feature information performed by the analyzing unit 12 is specified. When a region is specified in the image 4840 displayed in the page edit area 484, after the mode is switched to the mask setting mode from the edit mode by operating this button 4885, the registration tool 21 sets the region to the mask region.

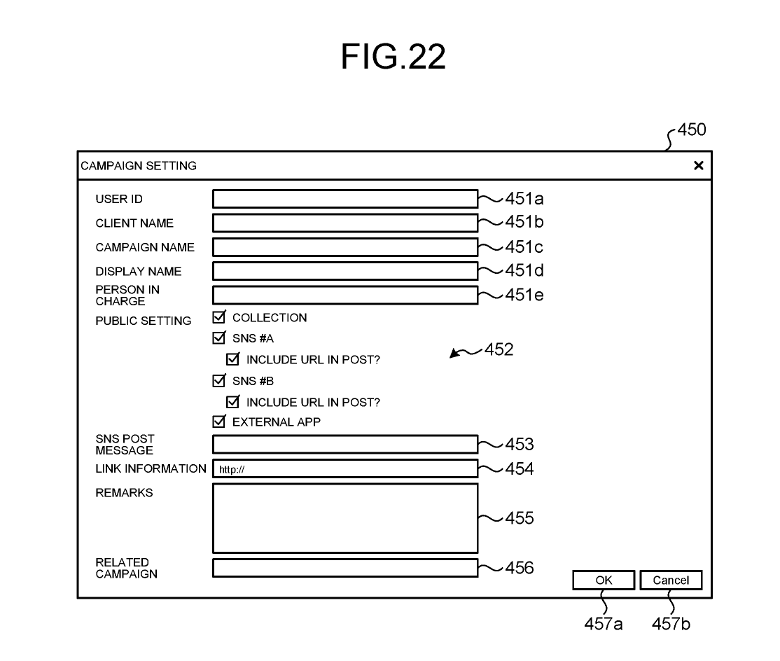

The button 4886 is a button that displays a campaign setting screen to set details of a campaign. FIG. 22 illustrates an example the campaign setting screen according to the embodiment. In the example shown in FIG. 22, a campaign setting screen 450 includes display areas 451a and 451b, input areas 451c to 451e, 453, 454, 455, and 456, a releasing-to-the public-method setting unit (hereinafter referred to as public-method setting unit) 452, and buttons 457a and 457b arranged therein. In the display areas 451a and 451b, values of the items “user ID” and “client name” of a record in the registration-information list screen 420 shown in FIG. 17 are respectively displayed unchangeably.

In the input area 451c, a campaign name is input. In the input area 451c, a value of the item “campaign name” of a record in the registration-information list screen 420 is input as a default value. In the input area 451d, a display name that is used when the campaign is displayed in the retrieval terminal 30 is input. In the input area 451e, for example, a name of a person in charge of registration of a campaign is input.

The public-method setting unit 452 sets a method for releasing a campaign to the public. Releasing to the public herein means an operation in the retrieval terminal 30 when a predetermined operation is performed in the retrieval terminal 30. In the example shown in FIG. 22, the public-method setting unit 452 includes “collection”, multiple social networking services (SNS) such as “SNS #A” and “SNS #B”, and “external app” as setting items. The public-method setting unit 452 is enabled to specify more than one releasing-to-the public method at the same time.

Among the releasing-to-the public methods that can be set in the public-method setting unit 452, the setting item “collection” stores information of a campaign into the retrieval terminal 30. The setting items “SNS #A” and “SNS #B” are to post information of a campaign on the SNS #A and the SNS #B, respectively. By checking a box of “include URL in post?” for the setting items “SNS #A” and “SNS #B”, a URL can be included in a post message. The setting item “external app” is to display information of a campaign using an external application program to an application program corresponding to the information processing system 1 in the retrieval terminal 30.

In the input area 453, it is input a post message used when information of a campaign is posted on the SNS #A and the SNS #B, when it has been set to be released to the public by the setting items “SNS #A” and “SNS #B” in the public-method setting unit 452. In the input area 454, link information (for example, a URI) of a campaign is input. In the input area 455, for example, remarks about a campaign are input.

Furthermore, in the input area 456, a campaign ID of a related campaign that is related to this campaign is input. The specifying unit 208 (refer to FIG. 12) specifies a campaign of the campaign ID input to this input area 456 as a related campaign of a campaign set to be a subject of setting in the campaign setting screen 450.

The button 457a reflects each information that is input in the input areas 451c to 451e, 453, 454, 455, and 456, and set to the public-method setting unit 452 as setting information of the campaign, and then the operation returns to the edit screen 480. Among this campaign setting information, information other than information of a related campaign is information included in metadata of the campaign. When the button 347a is operated, the registration tool 21 updates a record and metadata corresponding to the campaign, for example, based on information input into the input areas 451c to 451e, 453, 454, 455, and 456 and a setting value set by the public-method setting unit 452, and reflects the updated contents to the campaign information DB 16′. The button 457b is to return to the edit screen 480 without updating the record and metadata corresponding to the campaign.

Returning to explanation of FIG. 20, the button group 4887 includes three buttons to perform copy, paste, and deletion of information, respectively.

A button 4888 is to perform similar image check to check whether an image including a portion that is similar to a part or an entire image of an image (page) 4840 that is currently being displayed in the page edit area 484 of the edit screen 480 has already been registered in the retrieval server 10. This is performed subjecting the registration server 50 instead of the retrieval server 10, and subjecting an image set to be “public” by the setting information of the campaign out of images registered in the registration server 50 to the check. Not limited to this, an image set to be “non-public” registered in the registration server 50 may also be a subject of the check, and the retrieval server 10 may be directly a subject of the check. The registration tool 21 displays a retrieval result transmitted from the registration server 50 on the display unit 206. A user can perform reedition of the image based on this retrieval result.

At this time, the registration tool 21 may transmit only an image within a target region set according to an operation of the button 4884, for example, to the registration server 50 as a subject of the check, to request retrieval of a similar image. Moreover, the registration tool 21 can exclude an image in a mask region set according to an operation of the button 4885 from a subject of the check. Furthermore, the registration tool 21 may divide the image 4840 that is currently being displayed in the page edit area 484, and transmit each of divided images to the registration server 50 to request retrieval of a similar image, thereby performing the similar image check of each of the images.

The button 4889 is to instruct storage of a campaign being edited in the edit screen 480.

Returning to explanation of FIG. 14, when button 4889 is operated, the registration tool 21 shifts the processing to step S125, and starts storage processing of a campaign. When the storage processing started, the registration tool 21 shifts the processing to step S126, and determines whether the campaign to be stored is a campaign newly registered. The registration tool 21 determines, when the processing is shifted from step S122 described above to step S126, that the campaign is not a newly registered campaign, and shifts the process to step S127.

On the other hand, when the processing is proceeded from step S123 described above to the step S126, the registration tool 21 determines as a newly registered campaign, and shifts the process to step S130.

At step S130, the registration tool 21 subjects an image in which a target region is set out of images included in the campaign to be stored, to the similar image check to determine whether an image including a portion that is similar to a part or an entire image of each image described above. For example, the registration tool 21 transmits all images that are included in the campaign to be stored to the registration server 50, and requests retrieval of a similar image. When it is determined that a similar image is not registered in the registration server 50 based on the retrieval result at following step S131, the registration tool 21 shifts the processing to step S127.

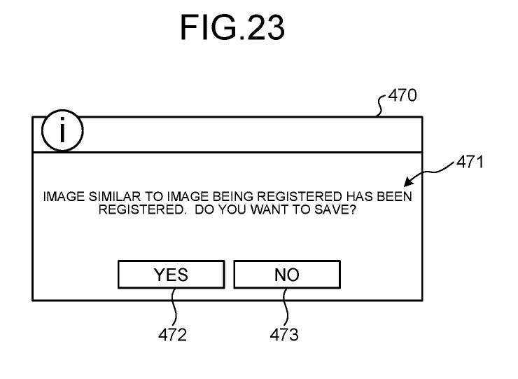

On the other hand, when determining that a similar image is registered in the registration server 50 based on the retrieval result at step S131, the registration tool 21 shifts the processing to step S132. The registration tool 21 displays a warning screen, for example, as shown in FIG. 23, on the display unit 206 at step S132. In the example shown in FIG. 23, a warning screen 470 displays a warning message 471 indicating that a similar image has already been registered in the registration server 50, and includes a “YES” button 472 and a “NO” button 473 arranged therein.

When the “NO” button 473 is operated in the warning screen 470, the registration tool 21 can perform avoidance processing with respect to registration of the similar image. As one example, the registration tool 21 displays a message to prompt for the avoidance processing with respect to the registration of the similar image on the display unit 206, and returns the processing to step S124. In this case, as the avoidance processing, for example, change of an image included in the campaign to be stored, setting of a mask region in the image, change of a target region, and the like can be performed. When the avoidance processing is performed, the processing shifts to step S127.

On the other hand, when the “YES” button 472 is operated in the warning screen 470, the registration tool 21 shifts the process to step S127 without performing the avoidance processing described above, and can register the image.

At step S127, the registration tool 21 transmits information of the campaign to the registration server 50, and requests the registration server 50 to update the registered information. For example, the registration tool 21 transmits each image included in the campaign, each association information associated with each image, and metadata of the campaign to the registration server 50. The registration server 50 updates the image DB 14, the association information DB 15, and the campaign information DB 16′ based on each information that is transmitted from the registration terminal in response to the request from the registration tool 21.

Upon transmitting the request for information update to the registration server 50 at step S127, the registration tool 21 returns the processing to step S105.

Operation Example of Retrieval Terminal According to Embodiment

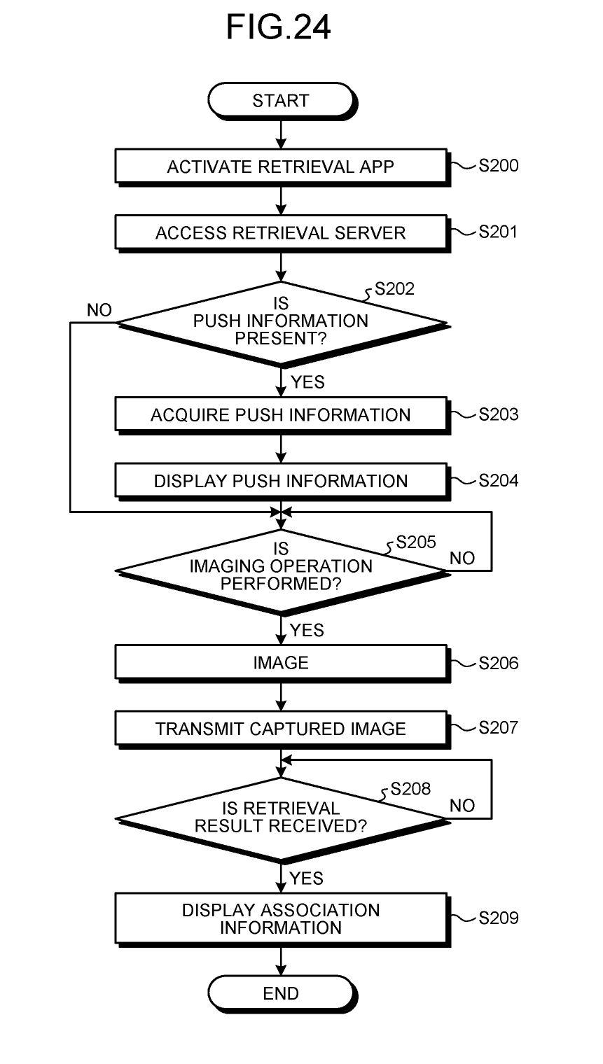

Next, an operation example of the retrieval terminal 30 according to the embodiment is explained using a flowchart in FIG. 24. At step S200, a retrieval app is activated, in the retrieval terminal, for example, by a user operation made to the retrieval terminal 30. At following step S201, the retrieval app accesses the retrieval server 10.

At accessing the retrieval server 10, the retrieval app transmits terminal identification information that enables to identify the retrieval terminal 30, to the retrieval server 10. As the terminal identification information, a MAC address that is assigned to the retrieval terminal 30, or an app ID that is created uniquely to installation of the retrieval app can be used.

At following step S202, the retrieval app determines whether push information addressed to the retrieval app itself is present in a predetermined storage location in the retrieval server 10. Although details are described later, the push information includes information about a related campaign. Moreover, the push information can include one or more pieces of information about a related campaign. When determining that push information addressed to the retrieval app itself is not present in a predetermine storage location in the retrieval server 10 at step S202, the retrieval app shifts the process to step S205.

Note that “addressed to itself” indicates the retrieval terminal 30 itself when the terminal identification information is a MAC address, and indicates the retrieval app itself when the terminal identification information is an app ID.

On the other hand, when determining that the push information addressed to itself is present in the retrieval server 10 at step S202, the retrieval app shifts the processing to step S203. At step S203, the retrieval app acquires the push information addressed to itself from the retrieval server 10. For example, the retrieval app acquires the push information by downloading the push information addressed to itself in the retrieval server 10 through the Internet 41 to the retrieval terminal 30. At following step S204, the retrieval app displays the push information acquired from the retrieval server 10 on the display device 3005 by the display unit 306.

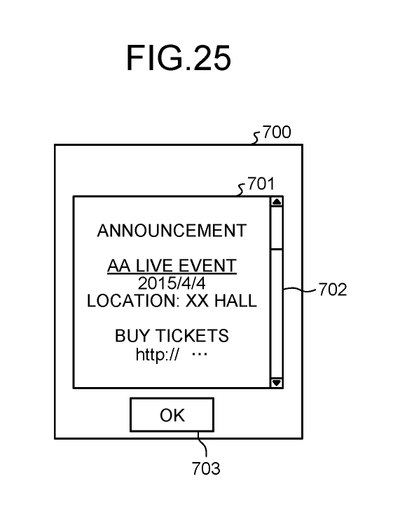

FIG. 25 shows an example of a display screen of push information displayed on the display device 3005 of the retrieval terminal 30 according to the embodiment. In the example shown in FIG. 25, push-information display screen 700 includes a display area 701 in which push information is displayed, and a button 703. Moreover, a scroll bar 702 to mover displayed contents in a vertical direction is arranged in the display area 701, and by operating the scroll bar 702, push information that cannot be displayed within the display area 701 can be displayed in the display area 701. The retrieval app closes the push-information display screen 700 when the button 703 is operated.

When push information includes information about more than one related campaign, this information about more than one related campaign can be displayed in the display area 701 with being arranged in chronological order of date of creation or date of release of campaign information of the related campaigns. It is not limited to this, the information about related campaigns may be displayed in random order. Moreover, making priority setting on the respective pieces of campaign information, campaign information having priority equal to or higher than predetermined priority may be selectively displayed out of the campaign information of the related campaigns.

At step S204, for example, when the button 703 is operated, to close the push-information display screen 700, the retrieval app shifts the processing to step S205. At step S205, the retrieval app determines whether an imaging operation is performed for the retrieval terminal 30. When determining that the imaging operation is not performed, the retrieval app returns the process to step S205.

When determining that the imaging operation is performed at step S205, the retrieval app shifts the process to step S206. At step S206, the retrieval app performs imaging processing according to the imaging operation, causing the imaging processing unit 3012 to control the imaging unit 3010. At following step S207, the retrieval app causes the retrieval requesting unit 3013 to transmit a captured image that is acquired by the imaging processing to the retrieval server 10, and causes the retrieval requesting unit 3013 to request the retrieval server 10 for image retrieval based on the captured image.

At following step S208, the retrieval app determines whether a retrieval result in response to the image retrieval request transmitted at step S207 is received from the retrieval server 10. When determining that a retrieval result is not received, the retrieval app returns the processing to step S208. On the other hand, when it is determined that a retrieval result is received from the retrieval server 10, the retrieval app shifts the process to step S209. At step S209, the retrieval app causes, by the UI control unit 3011, the display unit 306 to display association information included in the retrieval result received from the retrieval server 10 on the display device 3005. A display example of association information by the UI control unit 3011 is described later.

When the association information is displayed at step S209, a series of the processes in the flowchart shown in FIG. 24 is terminated.

Operation Example of Retrieval Server According to Embodiment

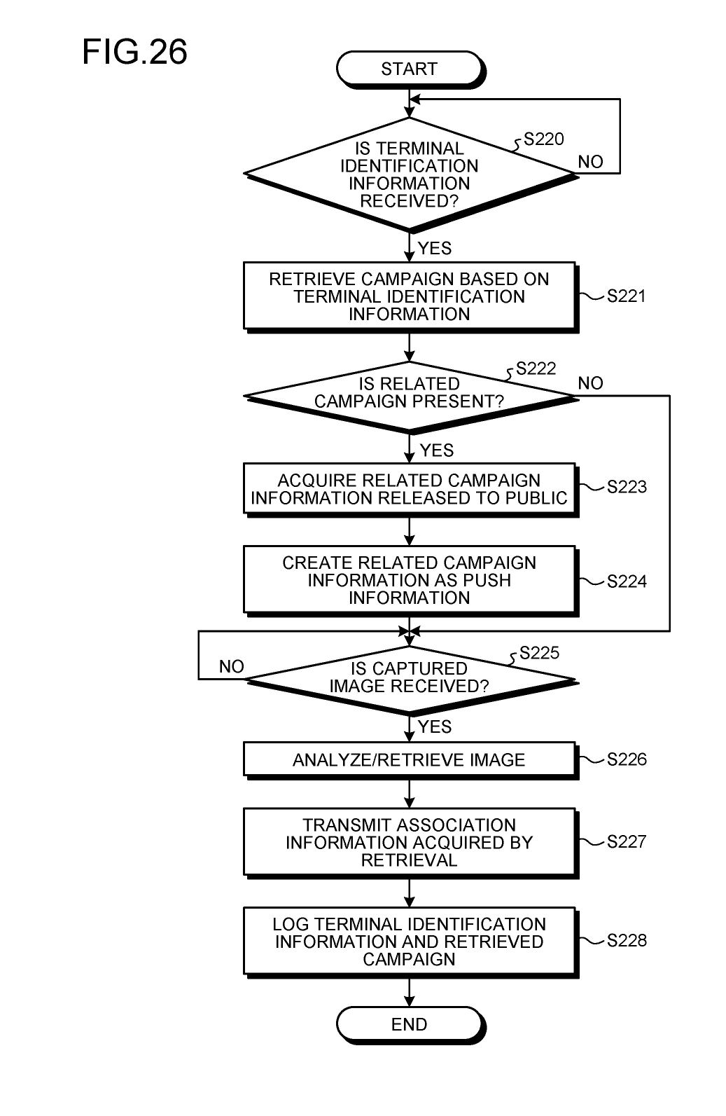

An operation example of the retrieval server 10 according to the embodiment is explained using a flowchart in FIG. 26. At step S220, the retrieval server 10 determines whether terminal identification information is received from the retrieval terminal 30 by the history managing unit 18 in the campaign managing unit 101. When it is determined that terminal identification information is not received, the history managing unit 18 returns the process to step S220. On the other hand, when it is determined that terminal identification information is received at step S220, the history managing unit 18 shifts the process to step S221.

At step S221, the history managing unit 18 retrieves a campaign ID corresponding to the terminal identification information received at step S220 from the history DB 17. More specifically, the history managing unit 18 retrieves history information where terminal identification information indicated in the item “terminal identification information” (refer to FIG. 7) coincides with the terminal identification information received at step S220, and acquires a campaign ID included in the retrieved history information.

At following step S222, the history managing unit 18 determines whether a related campaign corresponding to the campaign ID that is acquired at step S221 is present. More specifically, the history managing unit 18 retrieves campaign information where a campaign ID indicated in the item “campaign ID” (refer to FIG. 5) coincides with the campaign ID that is acquired at step S221 from the campaign information DB 16, and determines whether a campaign ID is stored in the item “related campaign ID” (refer to FIG. 5) of the retrieved campaign information. When it is determined that a related campaign is not present, the history managing unit 18 shifts the process to step S225.

On the other hand, when it is determined that a related campaign is present at step S222, the history managing unit 18 shifts the process to step S223. At step S223, the history managing unit 18 acquires information of a campaign being in public state from among campaign information that has been determined that a campaign ID is stored in the item “related campaign ID” at step S222. Specifically, the history managing unit 18 refers to a value of the item “state” (refer to FIG. 5) of the campaign information determined that a campaign ID is stored in the item “related campaign ID”, and acquires campaign information having the value “public”.

At step S223, when information of a campaign being in public state is not included in the campaign information that has been determined that a campaign ID is stored in the item “related campaign ID” at step S222, the history managing unit 18 shifts the process to step S225.

At following step S224, the history managing unit 18 creates push information described above that is to be presented to the retrieval terminal 30 based on the campaign information of the related campaign acquired at step S223. More specifically, the history managing unit 18 acquires campaign information where the item “campaign ID” (refer to FIG. 5) coincides with the campaign ID of the related campaign, and creates push information based on the acquired campaign information.

The history managing unit 18 stores the push information created at step S224, for example, into the retrieval server 10 at a predetermined location accessible for the retrieval terminal 30. Thus, the push information is presented to the retrieval terminal 30 from the retrieval server 10. As one example, when an app ID is used as the terminal identification information, the retrieval server 10 creates a URI corresponding to the app ID at creation of the app ID, and creates a storage location according to a pass indicated in this URI. The history managing unit 18 stores the push information into the storage location that is indicated by the URI corresponding to the app ID. The same applies to a case of using a MAC address as the terminal identification information.

As is described above, by determining a storage location of push information, in the retrieval terminal 30, the retrieval app acquires terminal identification information, such as the own app ID or the MAC address of the retrieval terminal 30 in which the retrieval app is installed, and can know, based on the acquired terminal identification information, the storage location of the push information addressed to the retrieval app itself. Therefore, at the time of accessing the retrieval server 10 at step S201 in the flowchart in FIG. 24 described above, the retrieval server 10 can easily to acquire push information addressed to the retrieval server 10 itself.

The push information can be created based on campaign information. For example, the history managing unit 18 can access URI indicated in the item “link information” (refer to FIG. 5) included in the campaign information, and acquire information to be presented to the retrieval terminal 30 as push information from a file stored in this URI.

Returning to explanation of the flowchart in FIG. 26, when the push information is presented to the retrieval terminal 30 at step S224 by the history managing unit 18, the process is proceeded to step S225. At step S225, the image retrieving unit 100 of the retrieval server 10 determines whether a captured image is received from the retrieval terminal 30 that is a source of the terminal identification information received at step S220. When it is determined that the captured image is not received, the image retrieving unit 100 returns the process to step S225.

On the other hand, when it is determined that a captured image is received at step S225, the image retrieving unit 100 shifts the process to step S226. Moreover, the received captured image is transferred to the retrieving unit 13 in the image retrieving unit 100, and transferred further to the analyzing unit 12 from the retrieving unit 13. At step S226, the analyzing unit 12 analyzes the received capture image to acquire a feature amount, and the retrieving unit 13 retrieves an image having high similarity to the captured image from the image DB 14 of the image retrieval DB 11 based on an analysis result.

At following step S227, the retrieving unit 13 acquires association information that is associated with the image retrieved from the image DB 14 at step S226. The retrieval server 10 transmits the association information acquired by the retrieving unit 13 at step S227 to the retrieval terminal 30 that is the source of the captured image received at step S225.

At following step S228, in the campaign managing unit 101 of the retrieval server 10, the history managing unit 18 stores information indicating the image retrieval that has been performed on the retrieval server 10 by the retrieval terminal 30 that is the source of the terminal identification information received at step S220 in the history DB 17 as history information. That is, the history managing unit 18 stores, in the history DB 17, as history information, the terminal identification information in which the campaign ID indicating the campaign that includes the image acquired as a result of the image retrieval, and access information that indicates date of access for the image retrieval to the retrieval server 10 by the retrieval terminal 30 corresponding to the terminal identification information are included in an associated manner.

When the history information is stored in the history DB 17, a series of the processes in the flowchart in FIG. 26 is terminated.

Presentation processing of push information at step S220 to step S224 described above is now briefly explained. As one example, the retrieval terminal 30 (retrieval app) identified by terminal identification information “10023875” in the history information in FIG. 7 described above is focused. Hereinafter, the retrieval terminal 30 (retrieval app) identified by the terminal identification information “10023875” is referred to as a subject terminal.

The subject terminal has retrieved an image included in campaign information indicated by the campaign ID “2” at “2014/12/27 13:41:00”. Moreover, the subject terminal has retrieved an image included in campaign information indicated by the campaign ID “1” at “2014/12/27 13:53:00”.

On the other hand, referring to FIG. 5, it is seen that campaign information indicated by a campaign ID “5” is associated with the campaign IDs “1” and “2” as related campaign IDs. Moreover, it is assumed that campaign information indicated by this campaign ID “5” is held, for example, on “2015/4/4”.

Here, it is considered a case in which the subject terminal accesses the retrieval server 10 at a time later than “2014/12/27 13:53:00” and prior to “2015/4/4” for image retrieval. In this case, the history managing unit 18 retrieves a campaign ID corresponding to the subject terminal from the history DB 17 at step S221 based on the terminal identification information “10023875” of the subject terminal received at step S220. Campaign information is retrieved. In the example shown in FIG. 7, the campaign IDs “1” and “2” are to be acquired as a retrieval result for the terminal identification information “10023875”.

The history managing unit 18 retrieves campaign information including these campaign IDs “1” and “2” in the item “related campaign ID” from the campaign information DB 16. In the example shown in FIG. 5, the campaign information of the campaign ID “5” includes the campaign IDs “1” and “2” in the item “related campaign ID”. Therefore, the history managing unit 18 determines that a related campaign is present at step S222 in FIG. 26, and acquires the campaign information of the campaign ID “5” as information of a related campaign. Moreover, in the campaign information of the campaign ID “5”, the value of the item “state” is “public”, and therefore, the process is proceeded to step S224.

At step S224, the history managing unit 18 acquires push information by accessing the URI indicated in the item “link information” of the campaign information of the campaign ID “5”. The history managing unit 18 then stores the acquired push information at a predetermined location accessible for the subject terminal. The subject terminal accesses the storage location of this push information, for example, at the time of activation of the retrieval app, acquires the push information, and displays the acquired push information (step S200 to step S204 in FIG. 24).

In the example shown in FIG. 5, the item “campaign name” of the campaign information of the campaign ID “5” is “AA live 15 spring”, and information about the “AA live” is presented in the display area 701 in FIG. 25. Furthermore, the fact that this event “AA live” is held on 2015/4/4, and a method of acquiring a ticket are indicated.

As described, in the embodiment, when the retrieval app is activated in the retrieval terminal 30, terminal identification information is transmitted from the retrieval terminal 30 to the retrieval server 10. The retrieval server 10 retrieves history information corresponding to the terminal identification information transmitted from the retrieval terminal 30 from the history DB 17. The retrieval server 10 then determines whether a related campaign is associated with campaign information that is indicated by a campaign ID included in the retrieved history information, and presents, when determining as associated, information about the related campaign based on the campaign ID of the related campaign to the retrieval terminal 30 as push information.

Therefore, according to the embodiment, a user that operates the retrieval terminal 30 can acquire information of other campaigns related to a result of past retrieval, for example, at the time of activation of the retrieval app. At this time, the user is not required to perform retrieval operation for a related campaign to the retrieval terminal 30, and therefore, can acquire other campaign information significantly easily.

Moreover, according to the embodiment, the retrieval server 10 retrieves information of a related campaign that corresponds to the retrieval terminal 30 based on the terminal identification information transmitted from the retrieval terminal 30, and transmits the retrieved information to the retrieval terminal 30. Therefore, a user of the retrieval terminal 30 can acquire related campaign information, for example, without performing user registration for a source providing the related campaign information. Therefore, it is possible to suppress leakage of personal information that can be caused by user registration.

Display Example of Image Retrieval Result in Retrieval Terminal

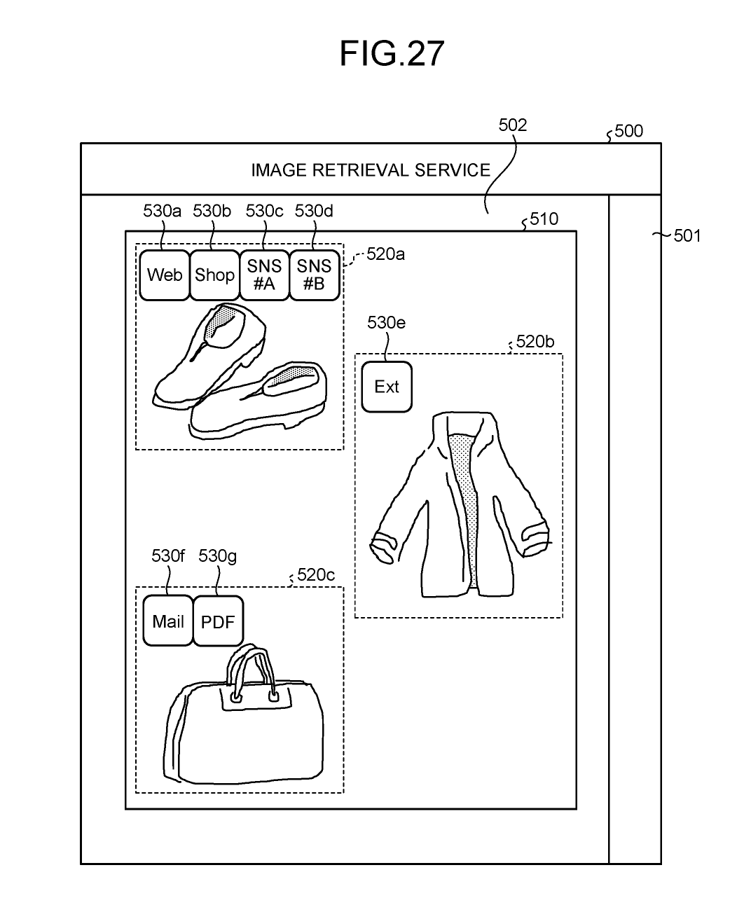

Next, a display example of association information at step S209 in the flowchart in FIG. 24 described above is explained using FIG. 27 to FIG. 29.

As described above, the retrieval server 10 associates association information with a target region that is specified in an image, and information of association between this target region and the association information is described by the XML code 140 shown in FIG. 3. The retrieval server 10 transmits a retrieval result including this XML code 140 to the retrieval terminal 30 as a result of image retrieval. The retrieval terminal 30 receives the XML code 140 included in the retrieval result that is transmitted from the retrieval server 10 by the receiving unit 303, and transfers the received XML code 140 to the UI control unit 3011 of the internal browser unit 301. The UI control unit 3011 creates a browsing screen based on the received XML code 140, to display by the display unit 306.

FIG. 27 shows a display example of a browsing screen that is displayed by control of the UI control unit 3011 according to the embodiment. As shown in FIG. 27, a browsing screen 500 includes a link display area 501 and a page-image display area 502. The page-image display area 502 is an area displaying a page 510 according to the XML code 140. The page size may be fixed, or included in the XML code 140. The UI control unit 3011 refers to FIG. 3, and performs display of target regions 520a, 520b, and 520c, in accordance with description of a row 142 of the XML code 140.

The UI control unit 3011 displays an image acquired according to link information described in the XML code 140 in the target regions 520a, 520b, and 520c. It is not limited to this, the UI control unit 3011 can display, when image data is included in the XML code 140, an image according to the image data in the target regions 520a, 520b, and 520c.

Furthermore, the UI control unit 3011 displays icon images 530a to 530g indicating association information that is associated respectively with the target regions 520a, 520b, and 520c in the target regions 520a, 520b, and 520c. In the example shown in FIG. 27, the four icon images 530a to 530d are displayed in the target region 520a, indicating that four pieces of association information are associated with the target region 520a. Similarly, the icon images 530f and 530g are displayed in the target region 520c, indicating that two pieces of association information are associated with the target region 520c. Moreover, the one icon image 530e is displayed in the target region 520b, indicating that one piece of association information is associated with the target region 520b.

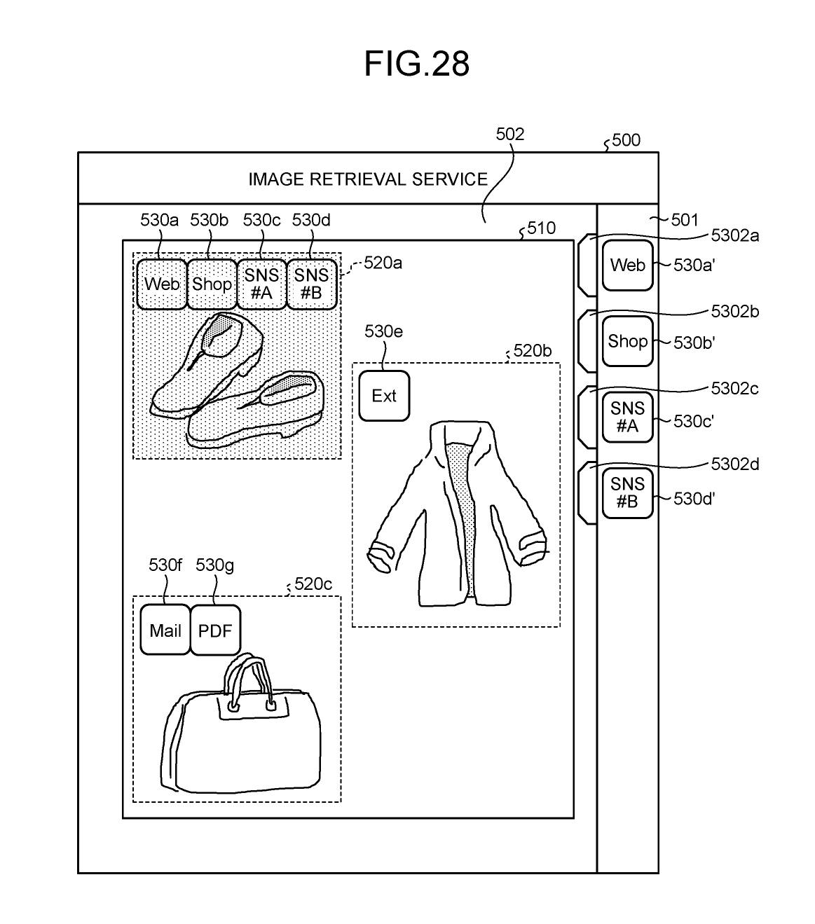

By specifying one target region to a display of the browsing screen 500, a user can use association information associated with the specified target region. FIG. 28 shows an example of specifying the target region 520a to the browsing screen 500 shown in FIG. 27. In the example shown in FIG. 28, the specified target region 520a is displayed in an emphasized manner. When the target region 520a is specified, the UI control unit 3011 displays icon images 530a′, 530b′, 530c′, and 530d′ that indicate association information associated with the specified target region 520a in the link display area 501. These icon images 530a′ to 530d′ correspond to the icon images 530a to 530d, respectively.

Moreover, the UI control unit 3011 displays tabs 5302a, 5302b, 5302c, and 5302d at positions respectively corresponding to the icon images 530a′, 530b′, 530c′, and 530d′ in the page-image display area 502. By operating the tabs 5302a, 5302b, 5302c, and 5302d, association information indicated by an icon image that corresponds to an operated tab becomes usable.

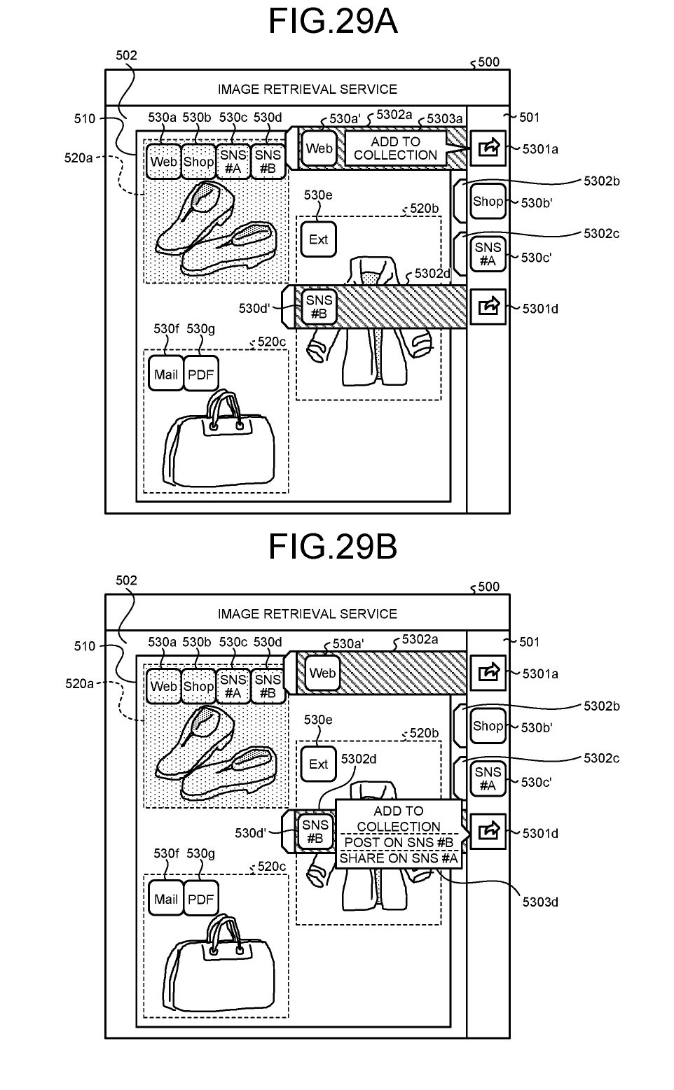

FIG. 29A and FIG. 29B show examples when the tabs 5302a and 5302d are operated in the display shown in FIG. 28. In this example, for example, when the tab 5302a is operated, an image of the tab 5302a is changed to an image as if the tab 5302a stretches toward a direction of the page-image display area 502. In addition, at an end of the extended portion of the tab 5302a, the icon image 530a′ corresponding to the tab 5302a is displayed. The same applies to the tab 5302d. Furthermore, at respective positions at which the icon images 530a′ and 530d′ has been displayed in the link display area 501, images 5301a and 5301d specifying use of functions indicated by the icon images 530a′ and 530d′ are displayed, respectively. By thus changing an image of the operated tab 5302a, it is indicated that association information indicated by the icon image 530a′ corresponding to the tab 5302a is in a usable state.

As one example, it is considered a case in which the internal browser unit 301 is specified as an activation application program to the icon image 530a′, and association information indicated by the icon image 530a′ specifies to be storable in the retrieval terminal 30. In this case, the UI control unit 3011 displays a message 5303a of “add to collection” on the tab 5302a as shown in FIG. 29A, and prompts a user to store the association information indicated by the icon image 530a′ in the retrieval terminal 30. When the icon image 5301a is operated, the UI control unit 3011 stores the association information indicated by the icon image 530a′, for example, in the storage 3006 of the retrieval terminal 30.

As another example, it is considered a case in which the internal browser unit 301 is specified as the activation application program to the icon image 530d′, and association information indicated by the icon image 530d′ specifies storage of the association information to the retrieval terminal 30, share on the SNS #A, and post on the SNS #B. In this case, the UI control unit 3011 displays a message 5303d indicating “add to collection”, “post on SNS #B”, and “share on SNS #A” are selectable on the tab 5302d as shown in FIG. 29B, and prompts a user to select a process. The UI control unit 3011 performs the process selected according to the message 5303d. For example, when the message “post on SNS #B” is selected, the UI control unit 3011 performs the post process for SNS #B based on the association information indicated by the icon image 530d′.

As another example, when the external browser unit 302 is specified as an activation application program to the icon image 530a′, the UI control unit 3011 calls and activates the external browser unit 302 by the calling unit 3014 in response to operation to the icon image 5301a corresponding to the icon image 530a′.

Modification of Embodiment

In the embodiment, as a related campaign, any campaign can be specified as long as it is a different campaign from a campaign of a reference source of the related campaign. At this time, it is preferable that a campaign released to the public chronologically later than the campaign of the reference source is specified as the related campaign.

Moreover, although activation of a retrieval app in the retrieval terminal 30 triggers presentation of information of a related campaign to the retrieval terminal 30 in the above description, it is not limited to this example. For example, the retrieval app may access the retrieval server 10 every predetermined time during operation to acquire push information. Furthermore, when the retrieval app operates in background of another app or an OS running in the retrieval terminal 30, the retrieval server 10 may be arranged to transmit push information every predetermined time to the retrieval terminal 30.

Moreover, although the retrieval server 10 creates push information, triggered by reception of the terminal identification information from the retrieval terminal 30 in the above description, it is not limited to this example. For example, the retrieval server 10 may create push information for each of the retrieval terminal 30 in advance. For example, the retrieval server 10 stores terminal identification information of the retrieval terminal 30 that has accessed to the retrieval server 10 for image retrieval, and can creates push information per stored terminal identification information.

Furthermore, it is possible to limit users enabled to specify a related campaign. As described above, the user management server 60 manages the user information in four levels of hierarchy: the overall administrator, the domain administrator, the client administrator, and the client, for example. In this case, it is considered that a user in higher level is set to be able to specify a related campaign with respect to a campaign taken in charge of by a user in lower level relative to the user in higher level.

For example, a user belonging to the level of “client” that is the lowest in hierarchy can specify a related campaign ID only for campaign information that is created or taken in charge of by the user of level “client”. A user belonging to the level of “client administrator” that is one level higher in hierarchy relative to the level “client” can specify a related campaign ID for campaign information that is created or taken in charge of by the user of level “client administrator”, and campaign information that is created or taken in charge of by a user belonging to the level “client” that is lower in hierarchy relative to the user of level “client administrator”.

As described above, it is possible to associate, with campaign information, arbitrary campaign information other than the campaign information as a related campaign, and it is also possible to limit campaign information to be associated with one campaign information as a related campaign. For example, it is considered that campaign information that can be associated with one campaign information as a related campaign is limited to campaign information that is created or taken charge of by the same user.

According to the present invention, an effect of enabling easy acquisition of association information that is associated with association information that has been acquired in image retrieval is produced.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing system comprising:
a terminal device;
an image retrieval device that includes a retrieving unit that retrieves an image similar to a retrieval subject image from an image-information registration unit in which an image and association information are registered in an associated manner, and a transmitting unit that transmits association information that is associated with a retrieved image to the terminal device;
an information processing apparatus that controls registration of the association information to the image-information registration unit;
a campaign-information registration unit that registers first campaign information and second campaign information in an associated manner, out of campaign information that includes the image and the association information associated with each other;
a storage unit that stores, as history information, the campaign information corresponding to the image retrieved by the retrieving unit based on the retrieval subject image transmitted from the terminal device and identification information to identify the terminal device in an associated manner; and
a presenting unit that presents, to the terminal device, association information that is included in the second campaign information registered in the campaign-information registration unit with being associated with the first campaign information that is associated with the identification information of the history information.

2. The information processing system according to claim 1, wherein
the second campaign information is the campaign information that is released to the public later than release of the first campaign information.

3. The information processing system according to claim 1, wherein
the campaign-information registration unit associates one or more pieces of the second campaign information with one piece of the first campaign information, and registers the pieces of first and second campaign information.

4. The information processing system according to claim 1, further comprising an input unit that accepts a user input, wherein
the campaign-information registration unit registers the first campaign information and the second campaign information that are specified by the user input to the input unit in an associated manner.

5. The information processing system according to claim 1, wherein
the terminal device includes a communication unit that transmits the retrieval subject image to the image retrieval device, and that acquires the association information transmitted from the transmitting unit, and
the communication unit acquires association information included in the second campaign information from the presenting unit, in response to activation of the communication unit.

6. The information processing system according to claim 5, wherein
the communication unit further acquires association information included in the second campaign information from the presenting unit repeatedly.

7. An information processing apparatus that controls registration of association information to image-information registration unit performed by an image retrieval device that includes a retrieving unit that retrieves an image similar to a retrieval subject image from the image-information registration unit in which an image and association information are registered in an associated manner, a transmitting unit that transmits association information that is associated with a retrieved image to a terminal device, a storage unit that stores campaign information including the image and the association information that correspond to the image retrieved by the retrieving unit based on the retrieval subject image that is transmitted from the terminal device, and that are associated with each other, and identification information to identify the terminal device in an associated manner, and a presenting unit that presents, to the terminal device, association information included in second campaign information that is included in the campaign information and that is registered in an associated manner with first campaign information included in the campaign information associated with the identification information of the history information, the information processing apparatus comprising:
an input unit that accepts a user input;
a specifying unit that specifies the second campaign information to be associated with the first campaign information associated with image information that includes the image and the association information, according to the user input made to the input unit; and
an association-information transmitting unit that transmits, to the image retrieval device, the first campaign information and the second campaign information that is specified by the specifying unit with respect to the first campaign information in an associated manner.

8. The information processing apparatus according to claim 7, wherein
the second campaign information is the campaign information that is released to the public later than release of the first campaign information.

9. The information processing apparatus according to claim 7, wherein
the specifying unit specifies one or more pieces of the second campaign information to be associated with one piece of the first campaign information.

10. An information processing method for an information processing system that includes a terminal device, an image retrieval device, and an information processing apparatus, the image retrieval device having a retrieving unit that retrieves an image similar to a retrieval subject image from an image-information registration unit in which an image and association information are registered in an associated manner, and a transmitting unit that transmits association information that is associated with a retrieved image to the terminal device, the information processing apparatus controlling registration of the association information to the image-information registration unit, the information processing method comprising:
registering first campaign information and second campaign information in an associated manner, out of campaign information that includes the image and the association information associated with each other;
storing, as history information, the campaign information corresponding to the image retrieved by the retrieving unit based on the retrieval subject image transmitted from the terminal device, and identification information to identify the terminal device in an associated manner; and
presenting association information that is included in the second campaign information registered at the registering with being associated with the first campaign information that is associated with the identification information of the history information.
